(19) United States
(12) Patent Application Publication
(10) Pub. No.: US 2025/0098706 A1
(43) Pub. Date: Mar. 27, 2025

(54) MARBLED MEAT ANALOG AND METHODS OF MAKING

(71) Applicant: Motif FoodWorks, Inc., Boston, MA (US)

(72) Inventors: Stefan K. BAIER, Boston, MA (US); Reed A. NICHOLSON, Boston, MA (US); Michael W. BOEHM, Boston, MA (US); Eugenio BORTONE, Boston, MA (US)

(21) Appl. No.: 18/833,906

(22) PCT Filed: Jan. 30, 2023
(86) PCT No.: PCT/US2023/061575

§ 371 Date: Jul. 28, 2024

Related U.S. Application Data
(60) Provisional application No. 63/304,447, filed on Jan. 28, 2022.

(51) Int. Cl. A23J 3/22; A23J 3/14; A23J 3/26; A23L 29/212; A23L 29/262

(52) U.S. Cl. CPC A23J 3/227; A23J 3/14; A23J 3/26; A23L 29/212; A23L 29/262

(57) ABSTRACT

Provided herein are compositions, methods, and systems for making a meat analog that comprise an oleogel, providing a non-homogenous distribution of lipids giving the resulting product a marbled meat-like. Some example compositions provided herein comprise vegetarian protein composition and cellulosic oleogels comprising plant derived lipids. Also provided herein are oleogel-composite preparations that may be incorporated into meat analogs and other food products.

### FIELD OF THE INVENTION

The present disclosure provides compositions and methods of making marbled meat analogs comprising oleogels. Additionally, the present disclosure relates to oleogel compositions and oleogel-composite formulations.

### CROSS REFERENCE TO RELATED APPLICATIONS

This application claims the benefit of the U.S. Provisional application No. 63/304,447 filed Jan. 28, 2021, the disclosures of which is herein incorporated by reference in its entirety.

### BACKGROUND OF THE INVENTION

Meat analogs or substitutes are food products that resemble the appearance, texture, and flavor of meat, but are made from vegetarian sources. Low to no-meat diets provide several health benefits to consumers including weight control, animal-borne disease control and longevity. Additionally, no-meat diets are sought by consumers concerned about animal welfare. Meat production greatly contributes to global warming and has other derogatory environmental impacts. This makes meat-analogs highly desirable alternatives for people seeking meat-like foods, without the environmental and health impact of routine meat consumption. The global meat substitute market is projected to reach close to $9,000 million by 2027 (Allied Market Research).

Currently available meat analogs include a wide range of products like seitan, tempeh, pressed tofu, texturized vegetable proteins (TVP), Quorn and high moisture meat analogs (HMMA). These are made by a range of methods available in the art including traditional recipes, fermentation and cooking, pressurized cooking, extrusion, low-shear, and high shear extrusion.

Despite considerable progress, meat substitutes have yet to cause a significant shift in dietary preferences for people desiring the mouthfeel and texture of meat. The food industry has developed multiple ingredients, processes, and technologies to manufacture meat analogs that mimic natural meat. However, the available techniques have so far failed to capture the desired structure, appearance, and the range of natural meats available to consumers. Currently available meat analog products are typically in the form of uniform, homogenous masses that lack the mouth feel and appearance of natural meat chunks. Natural meat has a plurality of textures and therefore provides a rich experience when consumed. To mimic this experience, meat analogs need to have the same variation in textures and appearance. Currently used methods to add texture to meat analogs are hard to scale up and do not provide satisfactory products at large scale. There is therefore a need in the art to address the limitations and provide an improved consumer meat-like product.

### SUMMARY OF THE INVENTION

One aspect of the present disclosure encompasses a meat analog composition comprising: a vegetarian protein composition, and an oleogel composition, wherein the meat analog has a non-homogenous dispersion of lipids providing a marbled texture and/or appearance.

In some aspects, of the current disclosure encompasses high moisture meat analog (HMMA) comprising: a vegetarian protein composition, preferably a plant-derived protein composition and an oleogel composition comprising: ethylcellulose, monoacylglycerol, and a non-animal sourced fat, preferably a plant-derived lipid, wherein the high moisture meat analog has a non-homogenous dispersion of lipids providing a marbled texture and/or appearance.

In some aspects, the meat analog composition comprises an oleogel composition comprising an oleogelator, and a plant-derived lipid.

In some aspects, the oleogelator is selected from a group including but not restricted a cellulose derivative, xanthan gum, carrageenan, a glycerol, a glyceride, waxes, proteins, sorbitanesters, fatty acids, sterol/sterol ester, lecithin/tocopherols, 12-Hydroxystearic acid, Ricinelaidic acid, and combinations thereof. Examples of cellulose derivatives include but are not restricted to methyl cellulose, ethyl cellulose, methylethyl cellulose, hydroxymethyl cellulose, hydroxyethyl cellulose, hydroxypropyl cellulose, hydroxyethyl cellulose, carboxymethyl cellulose, hydroxypropylmethyl cellulose or cellulose esters or ethers or salts thereof or combinations thereof. In some aspects, the oleogel in the meat analog composition comprises about 1-20% of the oleogelator by weight. Non-limiting examples of glycerol include glyceryl caprate, glyceryl caprylate/caprate, glyceryl citrate/lactate/linoleate/oleate, glyceryl cocoate, glyceryl cottonseed oil, glyceryl dioleate, glyceryl dioleste SE, glyceryl disterate, glyceryl distearate SE, glyceryl d/tribehenate, glyceryl lactoesters, glyceryl lactoeleate, glyceryl lactopalmitate/stearate, glyceryl laurate, glyceryl laurate SE, glyceryl linoleate, glyceryl mono/dilaurate, glyceryl mono/dioleate, glyceryl mono/distearate, glyceryl mono/distearate-palmitate, glyceryl oleate, glyceryl oleate SE, glyceryl palmitate, glyceryl palmitate lactate, glyceryl palmitate stearate, glyceryl ricinoleate, glyceryl ricinoleate SE, glyceryl soyate, glyceryl stearate, glyceryl stearate citrate, glyceryl state lactate, and glyceryl stearate SE.

In some aspects, the oleogel composition comprises about 1-60% of the oleogelator by weight.

In some aspects, the oleogelator is ethylcellulose with a viscosity of about 10 cP to about 100 cP; or about 20 to about 80 cP; or about 30 to about 60 cP; or about 40 to about 45 cP; or about 45 cP.

In some aspects, the oleogel composition comprises an ethylcellulose, a monoacylglycerol and a plant-derived lipid. Preferred amounts include but are not limited to about 1-20% by weight ethylcellulose, about 25-50% by weight monoacylglycerol, and about 40-74% by weight plant-derived lipid. In some aspects, the oleogel comprises about 2-7% by weight ethylcellulose, about 35-43% by weight monoacylglycerol, and about 51-63% by weight plant-derived lipid. In some aspects, the oleogel comprises about 4-5% by weight ethycellulose, about 36-45% by weight monoacylglycerol, and about 55-59% by weight plant-derived lipid. In some exemplary aspects the oleogel comprises about 5% by weight ethylcellulose 45 cP, about 38% by weight monoacylglycerol, and about 57% by weight plant-derived lipid. In some aspects, the oleogel composition comprises about 5% by weight ethylcellulose 45 cP, about 19% by weight glyceryl monooleate, about 19% by weight glyceryl monopalmitate or glyceryl monostearate, about 57% by weight plant derived oil.

In some aspects, the oleogel composition comprises a lipid, preferably a plant-derived lipid selected from a group including but not restricted to of soybean oil, rapeseed oil, canola oil, corn oil, sunflower oil, safflower oil, flaxseed oil, almond oil, peanut oil, palm oil, palm stearin, palm olein, palm kernel oil, high oleic soybean, canola, sunflower or safflower oils, acai oil, almond oil, amaranth oil, apricot seed oil, argan oil, avocado seed oil, babassu oil, ben oil, blackcurrant seed oil, Borneo tallow nut oil, borage seed oil, buffalo gourd oil, carob pod oil, cashew oil, castor oil, coconut oil, fractionated coconut oil (including medium chain triglyceride (MCT) oil made from coconut oil), coriander seed oil, corn oil, cottonseed oil, evening primrose oil, false flax oil, flax seed oil, grapeseed oil, hazelnut oil, hemp seed oil, kapok seed oil, lallemantia oil, linseed oil, macadamia nut oil, meadowfoam seed oil, mustard seed oil, okra seed oil, olive oil, palm kernel oil, fractionated palm kernel oil (including MCT oil made from palm kernel oil), pecan oil, pequi oil, perilla seed oil, pine nut oil, pistachio oil, poppy seed oil, prune kernel oil, pumpkin seed oil, quinoa oil, ramtil oil, rice bran oil, sesame oil, tea oil, thistle oil, walnut oil, wheat germ oil, hydrogenated palm kernel oil, hydrogenated palm stearin, fully hydrogenated soybean, canola or cottonseed oils, high stearic sunflower oil, enzymatically and chemically interesterified oils, butter oil, cocoa butter, and combinations thereof.

In some aspects, the oleogel composition further comprises one or more starches, or one or more dietary fibers, or combinations thereof, mixed with the oleogel composition to form an oleogel-composite, prior to addition to the protein composition.

In some aspects, the starch source in the oleogel-composite is selected from a group including but not limited to corn, potato, rice, wheat, arrowroot, guar gum, locust bean, tapioca, arracacha, buckwheat, banana, barley, cassava, konjac, kudzu, oca, sago, sorghum, sweet potato, taro, yams, fruit, vegetables, tubers, legumes, cereal grains, pseudograins, and combinations thereof. In some aspects, the one or more dietary fibers in the oleogel-composite are selected from a group including but not limited to pea fiber, oat fiber, bamboo fiber, rice bran, waxy maize, bean fiber, beet fiber, guar gum, pectin, carrageenan, apple fiber, citrus fiber, carrot fiber, barley fiber, psyllium husk, soy fiber, sesame flour, flaxseed fiber, nuts, garcinia fiber, chicory fiber, fenugreek fiber, and combinations thereof. In some aspects, the oleogel-composite comprises by weight, about 1%, or about 5%, or about 10%, or about 15%, or about 20%, or about 25%, or about 30%, or about 35%, or about 40% of one or more starches, or one or more dietary fibers, or combinations thereof.

In some aspects, the oleogel-composite is in a shape selected from pellets, pastes, pieces, strands, mince, and combinations thereof prior to addition to the plant-derived protein composition.

In some aspects, the meat analog comprises a vegetarian protein composition, preferably a plant-derived protein composition comprising proteins from any one of non-genetically modified or commoditized or hybridized or genetically modified soybean (soy), corn, peas, peanuts, almonds, nuts, chickpeas, favas, wheat gluten, and combinations thereof.

In some aspects, the plant-derived protein composition is selected from a group consisting of soy protein concentrate (SPC), soy protein isolate (SPI), pea protein concentrate, vital wheat gluten, and combinations thereof.

In some aspects, the meat analog further comprises one or more of emulsifiers, surfactants, sugars, starches, oligosaccharides, coloring agents, binding agents, stabilizing agents, flavor enhancers, flavoring agents, fragrance enhancers, vitamins, minerals, antioxidants, essential oils, pH regulators, dietary fibers, and gluten.

In some aspects, the current disclosure encompasses high moisture meat analogs comprising oleogels.

In some aspects, the vegetarian protein composition and the oleogel composition are mixed prior to an extrusion process.

In some aspects, the vegetarian protein composition and the oleogel composition are mixed in-line during extrusion.

In some aspects, the high moisture meat analog comprises compositions wherein the vegetarian protein composition is pre-mixed with water and extruded to form a precursor HMMA (pre-HMMA).

In some aspects, the pre-HMMA has undergone at least one prior extrusion step.

In some aspects, the pre-HMMA has undergone a high shear cooking process during the at least one prior extrusion step.

In some aspects, the pre-HMMA has undergone a low shear forming process during the at least one prior extrusion step.

In some aspects, the pre-HMMA is in a shape selected from any one of mince, pellets, paste, chunks, patties, or combinations thereof.

In some aspects, of the current disclosure, the high moisture meat analog comprises the pre-HMMA added to the oleogel composition in amounts of about 60% by weight pre-HMMA and about 40% by weight oleogel, or about 65% by weight pre-HMMA and about 35% by weight oleogel, or about 70% by weight pre-HMMA and about 30% by weight oleogel, or about 75% by weight pre-HMMA and about 25% by weight oleogel, or about 80% by weight pre-HMMA and about 20% by weight of oleogel prior to a second extrusion.

In some aspects, of the current disclosure the HMMA has a water content of about 40% to about 70%.

In some aspects, the current disclosure encompasses oleogel compositions. These compositions at least comprise an oleogelator and a lipid. In some aspects, the oleogel composition comprises cellulose derivative, one or more monoacylglycerol and a plant-derived lipid.

In some aspects, the current disclosure encompasses compositions of an oleogel-composite comprising an oleogel composition and a composition selected from a group including but not restricted to one or more polysaccharides, or oligosaccharides, starches, dietary fibers, pectin, maltodextrin, inulin, thickening agents, or any combination thereof.

In some aspects, the oleogel-composite of the current disclosure comprises one or more starches sourced from plants selected from a group including but not limited to corn, potato, rice, wheat, arrowroot, guar gum, locust bean, tapioca, arracacha, buckwheat, banana, barley, cassava, konjac, kudzu, oca, sago, sorghum, sweet potato, taro, yams, fruit, vegetables, tubers, legumes, cereal grains, pseudograins, and combinations thereof.

In some aspects, of the current disclosure the oleogel-starch composite is in a shape selected form pellets, paste, pieces, strands, mince, and combinations thereof prior to addition to the plant-derived protein formulation. In some aspects, the oleogel-composite comprises one or more dietary fibers selected from a group including but not limited to pea fiber, oat fiber, bamboo fiber, rice bran, waxy maize, bean fiber, beet fiber, guar gum, pectin, carrageenan, apple fiber, citrus fiber, carrot fiber, barley fiber, psyllium husk, soy fiber, sesame flour, flaxseed fiber, nuts, garcinia fiber, chicory fiber, and fenugreek fiber.

In some aspects, the oleogel-composite comprises by weight, about 1%, or about 5%, or about 10%, or about 15%, or about 20%, or about 25%, or about 30%, or about 35%, or about 40% of one or more starches, or one or more dietary fibers, or combinations thereof.

In some aspects, the oleogel-composite comprises an oleogel comprising ethylcellulose, a monoacylglycerol, and a plant-derived lipid. Preferred amounts include but are not limited to about 1-20% by weight ethylcellulose, about 25-50% by weight monoacylglycerol, and about 40-74% by weight plant-derived lipid. In some aspects, the oleogel comprises about 2-7% by weight ethylcellulose, about 35-43% by weight monoacylglycerol, and about 51-63% by weight plant-derived lipid. In some aspects, the oleogel comprises about 4-5% by weight ethycellulose, about 36-45% by weight monoacylglycerol, and about 55-59% by weight plant-derived lipid. In some exemplary aspects the oleogel comprises about 5% by weight ethylcellulose 45 cP, bout 19% by weight glyceryl monopalmitate or glyceryl monostearate, and about 57% by weight plant-derived lipid.

In some aspects, the oleogel-composite may be shaped in various forms including but not restricted to pellets, paste, pieces, agglomerations, strands, mince, and combinations thereof.

In some aspects, the oleogel-composite further comprises one or more of emulsifiers, surfactants, coloring agents, binding agents, stabilizing agents, flavor enhancers, flavoring agents, fragrance enhancers, and pH regulators.

In some aspects, the current disclosure also encompasses methods of preparing a high moisture meat analog (HMMA), comprising: introducing a vegetarian protein composition, preferably a plant-derived protein formulation through a feed assembly attached to an extruder, introducing an oleogel composition through a feed assembly attached to the extruder, wherein the extruder comprises at least a primary feed assembly and optionally a second feed assembly, thereby combining the plant-derived protein formulation and the oleogel composition in the extruder to form an HMMA with a non-homogenous dispersion of fat providing a marbled texture and/or appearance.

In some aspects, the extruder utilizes a cold extrusion process. In some aspects, the extruder is a co-rotating twin blade extruder.

In some aspects, the primary feed assembly is positioned in zone 1 of the extruder.

In some aspects, the second feed assembly is positioned in any one of zone 5-10 of the extruder.

In some aspects, the second feed assembly is positioned at the cooling die system. In some aspects, the cooling die system further comprises a static mixer.

In some aspects, the second feed assembly comprises a forced feeder attachment.

In some aspects, the second feed assembly comprises a vent port feeder attachment.

In some aspects, the plant-derived protein formulation and the oleogel composition are introduced through the same feed assembly.

In some aspects, the vegetarian protein composition and the oleogel composition are introduced through different feed assemblies.

In some aspects, the vegetarian protein composition and the oleogel composition are pre-mixed into a composite before introducing to the extruder.

In some aspects, the composite is in the form of pellets, paste, pieces, chunks, or mince.

In some aspects, the composite is introduced into the extruder through the second feed assembly.

In some aspects, the vegetarian protein composition is introduced through the primary feed assembly and the oleogel composition is added dropwise into the primary feed assembly during feeding.

In some aspects, the vegetarian protein composition is introduced through the primary feed assembly and the oleogel composition is introduced through the second feed assembly.

In some aspects, the oleogel composition is introduced continuously into the extruder.

In some aspects, the oleogel composition is introduced intermittently into the extruder.

In some aspects, the lipid is any non-animal lipid or fat, preferably plant-derived, selected from a group including but not limited to soybean oil, rapeseed oil, canola oil, sunflower oil, safflower oil, peanut oil, cottonseed oil, coconut oil, fractionated coconut oil, and combinations thereof.

In some aspects, the oleogel composition further comprises one or more of coloring agents, additional fats, binding agents, stabilizing agents, or emulsifying agents.

In some aspects, wherein the oleogel composition introduced into the extruder is incorporated into beads, pellets, chunks, or paste.

In some aspects, the oleogel composition introduced into the extruder is frozen.

In some aspects, the plant-derived protein formulation comprises at least one protein selected from the group consisting of: soy protein concentrate (SPC), soy protein isolate (SPI), and pea protein concentrate.

In some aspects, the plant-derived protein formulation further comprises one or more of emulsifiers, surfactants, sugars, starches, oligosaccharides, coloring agents, binding agents, stabilizing agents, flavor enhancers, flavoring agents, fragrance enhancers, vitamins, minerals, antioxidants, essential oils, pH regulators, dietary fibers, and gluten.

In some aspects, the plant-derived protein formulation further comprises water and when introduced into the extruder comprises previously extruded pre-HMMA.

In some aspects, the rotation speed of the twin-screw varies from between about 200 to about 800 rpm.

In some aspects, the specific mechanical energy going into the extrusion is about 50 to about 80 Wh/kg.

In some aspects, the temperature in one or more zones of the extruder ranges from about −20° C. to about −10° C., about −10° C. to about 0° C., about 0° C. to about 10° C., about 10° C. to about 20° C., about 20° C. to about 30° C., about 30° C. to about 40° C., about 40° C. to about 50° C., about 50° C. to about 60° C., about 60° C. to about 70° C., about 70° C. to about 80° C., about 80° C. to about 90° C., and about 90° C. to about 100° C.

In some aspects, the temperature in one or more zones is about 120° C. to about 250° C.

In some aspects, the method comprises a second extruder step.

In some aspects, the second extruder is a single-screw extruder.

In some aspects, the second extruder is a forming extruder.

In some aspects, the HMMA may be in any shape including but not restricted to a sheet, mince, pellets, paste, agglomeration, chunks, or patties.

In some aspects, the current disclosure also encompasses high moisture meat analog (HMMA) composition produced by the methods provided herein.

In some aspects, the current disclosure encompasses a high moisture meat analog (HMMA) comprising a vegetarian protein composition, and an oleogel composition comprising: about 1-10% by weight of the oleogel of ethylcellulose, about 20-50% by weight of the oleogel of one or more monoacylglycerols selected from glyceryl monooleate, glyceryl monopalmitate and glyceryl monostearate, and about 40-75% by weight of the oleogel of a plant-derived lipid, wherein the high moisture meat analog has a non-homogenous dispersion of lipids providing a marbled texture and/or appearance. In some aspects, the high moisture meat analog (HMMA) comprises a vegetarian protein composition, and an oleogel composition comprising: about 5% by weight of the oleogel of the ethylcellulose, about 38% by weight of the oleogel of the one or more monoacylglycerols selected from glyceryl monooleate, glyceryl monopalmitate and glyceryl monostearate, and about 57% by weight of the oleogel of the plant-derived lipid, wherein the high moisture meat analog has a non-homogenous dispersion of lipids providing a marbled texture and/or appearance. In some aspects, the high moisture meat analog (HMMA) comprises: a vegetarian protein composition, and an oleogel composition comprising: about 5% by weight of the oleogel of ethylcellulose 45 cP, about 19% by weight of the oleogel of glyceryl monooleate, about 19% by weight of the oleogel of glyceryl monopalmitate or glyceryl monostearate, and about 57% by weight of the canola oil, wherein the high moisture meat analog has a non-homogenous dispersion of lipids providing a marbled texture and/or appearance.

In some aspects, the current disclosure also encompasses an extrusion system for manufacturing a high moisture meat analog (HMMA) comprising, an extruder with a plurality of feed assembly configuration capabilities and configured to combine a plant-derived protein formulation and an oleogel composition to form an HMMA and has a non-homogenous dispersion of fat providing a marbled texture and/or appearance.

In some aspects, the current disclosure also encompasses a cooling die system in-line with an extruder, comprising a feed assembly operable to inject ingredients into the cooling die system. The cooling die system further comprises a static mixer.

### BRIEF DESCRIPTION OF THE FIGURES

FIG. 1 is a schematic of an exemplary twin-screw extruder divided into 10 zones for clarity (zones numbers and location may vary for different extruders), with the location of the primary feed port and potential locations for additional feed ports depicted by curved arrows.

FIG. 2A is a schematic of a twin-screw extruder where the primary feed port is used to introduce the plant-derived protein formulation (PDPF) into which the oleogel is added dropwise at a constant rate as described in Example 2. Both PDPF and oleogel compositions are thus added from the same primary feed port. Note that zone numbers and locations can vary depending on the type of extruder used.

FIG. 2B is a schematic of an exemplary functional twin-screw extruder where the primary feed port is used to introduce the plant-derived protein formulation (PDPF) into which the oleogel is added dropwise at a constant rate as described in Example 2. Both PDPF and oleogel compositions are added from the same primary feed port.

FIG. 3 shows photographs of high moisture meat analog (HMMA) obtained from the process outlined in Example 2 with the no-fat control, the HMMA product formed if sunflower oil is added with the PDPF and the HMMA product formed if oleogel is added with the PDPF.

FIG. 4 provides a schematic representation of the potential placements of the secondary feed assemblies (shown as curved arrows) for introducing oleogels into the extruder, while the PDPF is introduced from the primary feed port.

FIG. 5 depicts a schematic of a twin-screw extruder wherein a forced feeding assembly is added to zone 7 of the extruder and pre-mixed pre-HMMA and oleogel are added to the extruder through the attached force-feeding assembly as in Example 4.

FIG. 6 is a schematic depiction of the step 1 of Example 5 wherein a starch is mixed with the oleogel to form oleogel-composite pellets. A photograph of the thus formed oleogel-composite pellets is shown.

FIG. 7 is a schematic depiction of the step 2 of Example 5, wherein the pre-HMMA is added through feed assemblies placed at any one of the vent ports and the oleogel pellets are added though an additional feed assembly placed before the cooling die.

FIG. 8A is a schematic representation of a decoupled process wherein the PDPF is added at the first feed section as described in Example 6 and the resulting pre-HMMA is mixed with the oleogel mix and fed back into the extruder near the die plate prior to the cooling die.

FIG. 8B is a process schematic of Example 6 with photographs of each step.

FIG. 9 shows the potential position of the feed assembly at the cooling die, that further comprises a static mixer.

FIG. 10 shows photographs of secondary forming extruders used to form products that can be incorporated into foods.

### DETAILED DESCRIPTION

The current disclosure encompasses compositions and methods for making meat analogs comprising an oleogel. Natural meats include fat that is non-homogenously distributed and hence provides a rich textured mouth feel. The current disclosure helps capture the desired mouth feel by incorporation of oleogels into meat analogs. Oleogels are fat containing substances that are solid or gel-like at room temperature. The oleogel compositions described herein, when incorporated as described herein, impart a marbled texture and appearance to the meat analog products. The resulting non-homogenous incorporation of fat imparts a superior, more realistic mouth feel, that is not mushy or brittle but juicy and chewy. This enhances acceptance of meat alternatives that are better for health and the environment. The methods encompass novel ways of incorporating the disclosed oleogel compositions such that the products have a marbled meat-like distribution of lipids. Additionally, these methods are simpler to implement and scale-up than injection or mechanical manipulations currently used for texturization. Further, the oleogel compositions and methods of the present disclosure also result in products with more authentic textures and desirable characteristics than injection and mechanical manipulations. The meat analogs described herein comprise at least a vegetarian protein composition and an oleogel composition.

### I. Compositions

### A. Meat Analogs

Meat analogs as used herein comprises meat-like substance made from vegetarian ingredients. The term meat analog as used herein has the same meaning as commonly understood by one of ordinary skill in the art and includes but is not restricted to plant-derived meat, vegan meat, meat substitute, mock meat, meat alternative, imitation meat, vegetarian meat, fake meat or faux meat. Importantly, the meat analogs are such that the end-user is presented with a product that closely mimics traditional animal products. In some aspects, the current disclosure encompasses but is not limited to plant-derived meat or fungi-derived meat or diary meat or cultured meat or microbial biomass derived meat and combinations thereof which includes an oleogel. In some aspects, the current disclosure encompasses plant-derived meat including but not limited to fruit-based meat, legume-based meat, nut-based meat, leaf-derived meat, gluten-meat, flower-based meat, oilcakes derived meat, and combinations thereof and which include an oleogel. In some aspects, the meat analog may comprise a texturized vegetable protein (TVP) or a high moisture meat analog (HMMA) and combinations thereof and an oleogel. TVP are produced by a lower moisture process than HMMA and may comprise less than about 30% moisture by weight of the TVP. HMMA are typically produced by high moisture extrusion cooking (HMEC) or high moisture extrusion (HME) and can comprise a high final moisture content, such as, for example about 40% to about 80% moisture by weight of the HMMA.

### B. Vegetarian Ingredients and Sources

In some aspects, the current disclosure encompasses meat analogs comprising vegetarian ingredients. The term vegetarian ingredients as used herein comprises ingredients that are not sourced from meat or animal tissue products and are preferably obtained from plants, but may also be obtained from fungal, algal, microbial, dairy, and lab cultured sources or any other source that meet vegetarian standards as known.

Non-limiting examples of vegetarian ingredients include ingredients derived from legumes, oilseeds, cereal grains, fruits, tubers, pseudograins, fungi, algae, microbes, microbial biomass, dairy, lab cultured sources and combinations thereof. Legumes are non-genetically modified or genetically modified crops with seeds that are typically high in protein, non-limiting examples include soybean (also considered an oilseed), peanut, lentils, favas, peas, lupin, channa (garbanzo), and various dry edible beans. Oilseeds are non-genetically modified or genetically modified crops that are primarily grown for their oil content, including among others, soybean, sunflower, safflower, flax, canola, and rapeseed. Cereal grains are the seeds of non-genetically modified or genetically modified grasses which produce dry one-seeded fruits known as a kernel or grain. Cereal grains include rice, corn, wheat, barley, oats, spelt, rye, and sorghum. Tubers are non-genetically modified or genetically modified crops where a primary harvested component is the root, such as potatoes, tapioca, beets, carrots, arrowroot, and cassava. Pseudograins are non-genetically modified or genetically modified crops that share many characteristics of cereal grains but are not technically cereal grains since they are not grasses. Examples of pseudograins include buckwheat, amaranth, and quinoa. Ingredients in meat analogs may comprise vegetable waste material, such as, for example, at least one of a nut shell waste, nut hulls, nut pomace, fruit peels, fruit pomace, fruit pulp, whole defective fruits, vegetable peels, vegetable pomace, vegetable pulp, whole defective vegetables, coffee pulp, spent coffee grounds, bean skins, bean pods, whole defective beans, spent brew grains, distiller dried grains and solids, yeast waste, cereal hulls, cereal bran, mushrooms, small species, sugar beets pulp, or sugar beet molasses, or any combination thereof.

### C. Vegetarian Protein Sources and Compositions

The meat analog products described herein comprise at least of a vegetarian protein source and an oleogel. The vegetarian protein source may be a plant-derived protein source, or a source generally acceptable to vegetarianism including but not restricted to fungi, algae, microbes, lab cultures and dairy.

In some aspects, the current disclosure encompasses meat analogs comprising plant-derived protein formulations. The term plant-derived protein formulation as used here in comprise compositions with at least one plant-sourced protein ingredient. Non-limiting examples of plant-derived proteins include proteins sourced from seeds, tubers, oilcakes, nuts, grains, pseudograins, fruits, legumes, plant waste or any part of a plant. In some aspects, the plant-derived protein may be sourced from non-genetically modified or commoditized or hybridized or genetically modified soybean (soy), corn, peas, peanuts, almonds, nuts, chickpeas, favas, wheat gluten, oilseeds, lentils, and combinations thereof.

In some aspects, the current disclosure encompasses meat analogs comprising protein formulations derived from non-plant sources including but not restricted to fungi-derived proteins or diary proteins or cultured proteins or microbial biomass derived proteins.

In some aspects, the current disclosure encompasses meat analogs comprising combinations of protein formulations from a plurality of vegetarian sources. In some aspects, the protein formulations may comprise an iron containing protein selected from a group consisting of hemoglobin, myoglobin, leghemoglobin, non-symbiotic hemoglobin, chlorocruorin, erythrocruorin, neuroglobin, cytoglobin, protoglobin, truncated 2/2 globin, HbN, cyanoglobin, HbO, Glb3, and Hell's gate globin I, bacterial hemoglobins, ciliate myoglobins, flavohemoglobins.

In exemplary aspects, soy protein isolate (SPI), soy protein concentrate (SPC), soy flour, soy cakes, hydrolyzed soy protein and mixtures thereof maybe utilized in the protein composition. Examples of soy protein isolates that are useful in the present invention are commercially available, for example, from Solae, LLC (St. Louis, Mo.), and include SUPRO® 500E, SUPRO® 620, SUPRO® 545, SUPRO® 8000, SUPRO® 710, SUPRO® 313, and SUPRO® 670. Examples of suitable soy protein concentrates useful in the invention include Procon 2100, Alpha 12, Alpha 5800, and ProMax 70N which are commercially available from Solae, LLC (St. Louis, Mo.) In exemplary aspects soy protein concentrate may be mixed with soy protein isolate as a source of soy component of the plant protein formulation. In some aspects, of the current disclosure the soy protein component may comprise soy protein isolate mixed with soy protein concentrate at a weight ratio of about 95%:about 5% or about 90%:about 10% or about 85%:about 15% or about 80%:about 20% or about 75%:about 25% or about 70%:about 30% or about 65%:about 35% or about 60%:about 40% or about 55%:about 45% or about 50%:about 50%, and intermediate ratios thereof.

In some aspects, pea protein isolate, pea protein concentrate, textured pea protein, pea protein flour, hydrolyzed pea protein, pea globulin, pea albumin, and mixtures thereof may be utilized in protein compositions.

In some aspects, the plant protein formulation may comprise ingredients derived from non-genetically modified or commoditized or hybridized or genetically modified wheat including but not limited to wheat gluten, wheat flour or vital wheat gluten. An example of a commercially available wheat gluten that may be utilized in the invention is Gem of the West Vital Wheat Gluten, either regular or organic, available from Manildra Milling (Shawnee Mission, Kans.). In some aspects, the plant protein formulation may comprise one or more legume derived protein mixed with a wheat derived protein. In some aspects, the plant protein formulation may comprise one or more legume derived protein mixed with about 15%, to about 10%, to about 5%, to about 2%, to about 1% of vital wheat gluten by weight of the plant protein formulation. In some aspects, the plant protein formulation may comprise a mixture of soy protein isolate, soy protein concentrates and vital wheat gluten. In some exemplary aspects, the plant protein formulation may comprise a mixture of soy protein isolate, soy protein concentrate, and vital wheat gluten with the vital wheat gluten forming about 15%, to about 10%, to about 5%, to about 2%, to about 1% of the plant protein formulation.

### D. Oleogel Compositions

The current disclosure encompasses compositions of meat analogs comprising an oleogel composition. Oleogels are used in the disclosed meat analog compositions to provide a non-uniform dispersion of fat through the meat analog thus providing a marbled texture and mouthfeel like natural meat.

The term “oleogel” as used herein refers to lipid containing materials that comprise liquid oil or fat or mixture thereof trapped in a network of structuring molecules forming a gel. In some aspects, of this disclosure, oleogels are semisolid systems. The term “gel” as used herein, has the same meaning as commonly used in the art. It is a material having a continuous structure with macroscopic dimensions that is permanent on the time scale of an analytical experiment and is solid-like in its rheological properties (Flory, 1974). Gels elastically deform rather than flow, and exhibit substantially linear viscoelastic characteristics, at stresses below their yield stress. Gels have a melting point. Gels are defined by their rheological properties, in particular their yield stress and the ratio of their elastic modulus to their viscous modulus (G′/G″) as measured at 20° C. and 1 Hz in a conventional viscoelastic analyzer. Gel-like behavior is characterized by G′/G″ greater than about 1 under these conditions. The gels of the present invention suitably have yield stresses greater than about 100 Pa, more suitably greater than about 200 Pa, for example from about 200 Pa to about 1000 Pa. In some aspects, the oleogels encompassed in disclosure have yield stresses from about 200-300 Pa, or about 300 Pa to about 400 Pa, or about 400 Pa to about 500 Pa, or about 500 Pa to about 600 Pa, or about 600 Pa or about 700 Pa, or about 700 Pa to about 800 Pa, or about 800 Pa to about 900 Pa, or about 900 Pa to about 1000 Pa.

In their most basic composition, oleogels comprise at least a lipid, fat, or oil (together referred herein as lipid or lipids) and an oleogelator. Oleogelators or structurants or organogelators are the structuring components that form a scaffold for the lipid or fat or oil component of the oleogel. The oleogelator thus provides a structuring mechanism to the lipid continuous phase making it of gel consistency.

In some aspects, of the disclosure, the oleogelator may be selected from a list including but not limited to a polymer, waxes, amphiphiles or combinations thereof. In some aspects, of the disclosure, the oleogelator may comprise a polymer compound including but not limited to a cellulose derivative, for example methyl cellulose, ethyl cellulose, methylethyl cellulose, hydroxymethyl cellulose, hydroxyethyl cellulose, hydroxypropyl cellulose, hydroxyethyl cellulose, carboxymethyl cellulose, hydroxypropylmethyl cellulose or cellulose esters or ethers or derivatives or salts thereof, one or more protein, carrageenan and combinations thereof. In a preferred embodiment, the cellulose derivative is ethyl cellulose. In some aspects, the oleogelator may comprise mixed particles comprising mixtures of monoacylglycerols, diacylglycerols, waxes, proteins, sorbitanesters, fatty acids and polymers. In some aspects, the oleogelator may comprise one or more of monoglycerides, diglycerides or mixed monoglycerides and diglycerides including the following: glyceryl caprate, glyceryl caprylate/caprate, glyceryl citrate/lactate/linoleate/oleate, glyceryl cocoate, glyceryl cottonseed oil, glyceryl dioleate, glyceryl dioleste SE, glyceryl disterate, glyceryl distearate SE, glyceryl d/tribehenate, glyceryl lactoesters, glyceryl lactoeleate, glyceryl lactopalmitate/stearate, glyceryl laurate, glyceryl laurate SE, glyceryl linoleate, glyceryl mono/dilaurate, glyceryl mono/dioleate, glyceryl mono/distearate, glyceryl mono/distearate-palmitate, glyceryl oleate, glyceryl oleate SE, glyceryl palmitate, glyceryl palmitate lactate, glyceryl palmitate stearate, glyceryl ricinoleate, glyceryl ricinoleate SE, glyceryl soyate, glyceryl stearate, glyceryl stearate citrate, glyceryl state lactate, glyceryl stearate SE. As is known in the field, the terms ‘glyceryl’ and ‘glycerol’ are considered interchangeable. For example ‘glyceryl monooleate’ and ‘glycerol monooleate’ are interchangeable terms and reflect the same compound. In a preferred embodiment, the oleogelator comprises one or more of glycerol monooleate, glycerol monopalmitate and glycerol monostearate. In some aspects, of the disclosure the oleogelator may be a binary fibril including but not restricted to sterol/sterol ester or lecithin/tocopherols. In some aspects of the disclosure the oleogelator may be a pure fibril including but not restricted 12-Hydroxystearic cid, or Ricinelaidic acid. In some aspects the oleogelator may comprise pure particles including but not limited to monoacylglycerols, diacylglycerols, waxes, proteins, sorbitanesters, fatty acids. In some aspects, the oleogelator may comprise a liquid crystal particle including but not limited to lecithin/water, monoacylglycerol/water, or ceramides.

In some aspects, the oleogel may comprise about 1% to about 60% of one or more oleogelators by weight of the oleogel. In some aspects, of the current disclosure, the oleogel comprises at least about 0.1%, or at least about 0.5%, or at least about 1%, or at least about 1.5% or at least about 2%, or at least about 2.5% or at least about 3%, or at least about 4%, or at least about 5%, or at least about 6%, or at least about 7%, or at least about 8%, or at least about 9%, or at least about 10% or at least about 15%, or at least about 20%, or at least about 25%, or at least about 30%, or at least about 35%, or at least about 40%, or at least about 45% or at least about 50% or more, or at least about 60% or more of one or more oleogelator by weight of the oleogel.

In some aspects, the current disclosure comprises oleogels comprising ethylcellulose (EC) polymers as oleogelator. Ethylcellulose polymer as used herein, comprises a derivative of cellulose in which some of the hydroxyl groups on the repeating glucose units are converted into ethyl ether groups. The number of ethyl ether groups can vary. The viscosity grades of ethylcellulose reflect the molecular weight of the ethylcellulose. In some aspects, of the current disclosure, the oleogel comprises ethylcellulose of intermediate viscosities such as between about 10 cP to about 100 cP, wherein the cP values refer to viscosity in centipoise of a 5% solution of the EC in 80% toluene/20% ethanol at 25° C. Viscosity can be measured by any of the standard viscometer, rheometers or viscoelastic analyzers known in the art. In some aspects, the oleogel comprises ethylcellulose of viscosity of about 22 cP to about 50 cP. In some aspects, the oleogel comprises ethylcellulose of viscosity of about 10 cP, or about 15 cP, or about 20 cP, or about 22 cP, or about 25 cP, or about 30 cP, or about 35 cP, or about 40 cP, or about 45 cP, or about 50 cP, or about 55 cP, or about 60 cP, or about 65 cP or about 70 cP, or about 75 cP, or about 80 cP, or about 85 cP, or about 90 cP, or about 95 cP, or about 100 cP or intermediate viscosities. In some aspects, of the current disclosure the oleogel comprises about 1% to about 20% of ethylcellulose by weight of the oleogel. In some aspects, of the current disclosure, the oleogel comprises about 1%, or about 2%, or about 3%, or about 4%, or about 5%, or about 6%, or about 7%, or about 8%, or about 9%, or about 10%, or about 11%, or about 12%, or about 13%, or about 14%, or about 15%, or about 16%, or about 17%, or about 18%, or about 19%, or about 20% of ethylcellulose by weight of the oleogel.

Various types of lipids may be used in the oleogel. In some aspects, of the current disclosure, the lipid is a plant derived lipid such as, but not limited to, soybean oil, canola oil, corn oil, sunflower oil, safflower oil, flaxseed oil, almond oil, peanut oil, fish oil, algal oil, palm oil, palm stearin, palm olein, palm kernel oil, fractionated palm kernel oil (including Medium Chain Triglyceride (MCT) oil made from palm kernel oil), high oleic soybean, canola, sunflower or safflower oils, acai oil, almond oil, amaranth oil, apricot seed oil, argan oil, avocado seed oil, babassu oil, ben oil, blackcurrant seed oil, Borneo tallow nut oil, borage seed oil, buffalo gourd oil, carob pod oil, cashew oil, castor oil, coconut oil, fractionated coconut oil (including Medium Chain Triglyceride (MCT) oil made from coconut oil), coriander seed oil, corn oil, cottonseed oil, evening primrose oil, false flax oil, flax seed oil, grapeseed oil, hazelnut oil, hemp seed oil, kapok seed oil, lallemantia oil, linseed oil, macadamia oil, meadowfoam seed oil, mustard seed oil, okra seed oil, olive oil, palm kernel oil, pecan oil, pequi oil, perilla seed oil, pine nut oil, pistachio oil, poppy seed oil, prune kernel oil, pumpkin seed oil, quinoa oil, ramtil oil, rice bran oil, sesame oil, tea oil, thistle oil, walnut oil, wheat germ oil, hydrogenated palm kernel oil, hydrogenated palm stearin, fully hydrogenated soybean, canola or cottonseed oils, high stearic sunflower oil, enzymatically and chemically interesterified oils, butter oil, cocoa butter, and mixtures thereof. A portion, for example up to about 50% w/w, of the oils may be replaced by one or more fats. Non-limiting examples of fat that can be used include butter, ghee, and margarine. The plant derived lipid can also be hydrogenated or partially hydrogenated. In some aspects, of the current disclosure, the oleogel comprises about 99% by weight to about 20% by weight of lipids. In some aspects, the oleogel comprises about 99%, or about 98% or about 97%, or about 96%, or about 95%, or about 90%, or about 85%, or about 80%, or about 75%, or about 70%, or about 65%, or about 60%, or about 55%, or about 50%, or about 45%, or about 40%, or about 35%, or about 30%, or about 25%, or about 20%, or about 10% or intermediate percentages of lipid by weight of the oleogel.

In some aspects, of the current disclosure, the oleogel further comprises a monoacylglycerol. In some aspects, the oleogel comprises about 3% monoacylglycerol to about 50% monoacylglycerol by weight of the oleogel. In some aspects, the oleogel comprises about 3%, or about 5%, or about 10%, or about 15%, or about 20%, or about 25%, or about 30%, or about 35%, or about 40%, or about 45%, or about 50% of monoacylglycerol by weight of the oleogel. In some exemplary aspects of the current disclosure, the oleogel comprises about 38% of monoacylglycerol by weight.

In some aspects, the oleogel may comprise additional ingredients. Non-limiting examples of such ingredients include emulsifiers, surfactants, sugars, starches, oligosaccharides, coloring agents, binding agents, stabilizing agents, flavor enhancers, pH regulators, soy fiber and other dietary fibers, gluten, and mixtures thereof. In some aspects, the oleogel may comprise stabilizing agents that help maintain structure or state as temperature increases. Non-limiting examples of surfactant/solvent components include, polyoxyethylene sorbitan monostearate (Tween 60), sorbitan monooleate (SMO or Span 80), sorbitan monostearate (SMS or Span 60), glyceryl monooleate (GMO), glyceryl monostearate (GMS) glyceryl monopalmitate (GMP), polyglyceryl ester of lauric acid-polyglyceryl polylaurate (PGPL), polyglyceryl ester of stearic acid-polyglyceryl polystearate (PGPS), polyglyceryl ester of oleic acid (PGPO)-polyglyceryl polyoleate (PGPO), and polyglyceryl ester of ricinoleic acid (PGPR)-polyglyceryl polyricinoleate (PGPR). Non-limiting examples of a suitable colorant include FD&C colors, such as blue no. 1, blue no. 2, green no. 3, red no. 3, red no. 40, yellow no. 5, yellow no. 6, and the like; natural colors, such as roasted malt flour, caramel coloring, annatto, chlorophyllin, cochineal, betanin, turmeric, saffron, paprika, lycopene, elderberry juice, pandan, butterfly pea and the like, titanium dioxide, and any suitable food colorant known to the skilled artisan.

In some aspects, the oleogel comprises canola oil in the range of about 30-75% w/w, ethylcellulose 45 cP in the range of 1-20% w/w, glyceryl monooleate in the range of about 1-30% w/w and glyceryl monopalmitate or glyceryl monostearate in the range of about 1-30% w/w. An exemplary formulation may include canola oil (57% w/w), ethylcelullose (EC) 45 cP (5% w/w), glyceryl monooleate (19% w/w) and glyceryl monopalmitate or glyceryl monostearate (19% w/w).

### E. Oleogel-Composites

In some aspects, of the current disclosure, the oleogel after gelation may be mixed with other ingredients including but not limited to polysaccharides, oligosaccharides, sugars, starches, dietary fibers, glycogen, pectin, maltodextrin, inulin, thickening agents, and combinations thereof to form oleogel-composites that can be added to meat analogs and other food products. These composites provide further texture to the oleogel composition, such that when incorporated into a food product, the oleogel retains more of its texture and flavor and disperses unevenly. These oleogel composites provide further advantages including greater stability, easier shipping, stand-alone product that can be incorporated at a later date and location.

In some aspects, of the current disclosure, the oleogel may be mixed with a starch to form an oleogel-composite prior to addition to the vegetarian or preferably a plant-derived protein composition. Non-limiting examples of suitable starches may include starch derived from corn, potato, rice, wheat, arrowroot, guar gum, locust bean, tapioca, arracacha, buckwheat, banana, barley, cassava, konjac, kudzu, oca, sago, sorghum, sweet potato, taro, yams, fruit, vegetables, tubers, legumes, cereal grains, pseudograins, and mixtures thereof. Edible legumes, such as but not limited to favas, lentils, and peas, are rich in suitable starches. Suitable starches can also include the whole grain flours of these ingredients. In some aspects of the current disclosure, the oleogel composite comprises about 1% starch, to about 5% starch, to about 10% starch, to about 15% starch, to about 20% starch, to about 25% starch, to about 30% starch, to about 35% starch, to about 40% starch by weight of the oleogel-composite.

In some aspects, of the current disclosure, the oleogel may be mixed with dietary fibers including but not limited to pea fiber, oat fiber, bamboo fiber, rice bran, waxy maize, bean fiber, beet fiber, guar gum, pectin, carrageenan, apple fiber, citrus fiber, carrot fiber, barley fiber, psyllium husk, soy fiber, sesame flour, flaxseed fiber, nuts, garcinia fiber, chicory fiber, and fenugreek fiber and combinations thereof to form a oleogel-composite. In some aspects of the current disclosure, the oleogel composite comprises about 1% dietary fiber, to about 5% dietary fiber, to about 10% dietary fiber, to about 15% dietary fiber, to about 20% dietary fiber, to about 25% dietary fiber, to about 30% dietary fiber, to about 35% dietary fiber, to about 40% dietary fiber by weight of the oleogel-composite.

In some aspects, the oleogel composite may comprise one or more of polysaccharides, oligosaccharides, starches, sugars, dietary fibers, glycogen, pectin, maltodextrin, inulin, thickening agents, and combinations thereof at about 1%, at about 5%, at about 10%, at about 15%, at about 20%, at about 25%, at about 30%, at about 35%, at about 40% by weight of the oleogel-composite.

In some aspects, these oleogel-composites may further comprise emulsifiers, surfactants, sugars, coloring agents, binding agents, stabilizing agents, flavor enhancers, flavoring agents, fragrance enhancers, vitamins, minerals, antioxidants, essential oils, pH regulators, dietary fibers, gluten, and mixtures thereof.

In some aspects, of the current disclosure, the oleogel-composite is formed using an extrusion process prior to addition to a protein composition. In some aspect of the current disclosure, the oleogel composite has not undergone an extrusion process prior to addition to a protein composition. In some aspects, the oleogel-composite is formed by mixing the ingredients together by any of the mixing methods known in the art including but not limited to blenders, conical drums, mixing drums, belt blenders, ribbon blender, Hobart mixers, mechanical kneading equipment, extruders, high shear extruders, forming extruders and low shear extruders, piston-type extruders, screw-type extruders, and combinations thereof. Exemplary forms of oleogel-composite prior to addition to the protein composition are pellets, paste, pieces, chunks, beads, minced.

In some aspects, the oleogel-composite composition can be incorporated into meat analogs by methods provided herein or any method known in the art. In some aspects, the oleogel-composite may be incorporated into other food products where desired.

### F. Additional Ingredients

The meat analogs described herein comprising a protein base and an oleogel may further comprise other constituents to provide desirable characteristics including better flavor, stability, greater shelf life, better texture, and health benefits.

In some aspects, of the current disclosure, the meat analog may further comprise one or more optional ingredients, non-limiting examples of such ingredients include emulsifiers, surfactants, sugars, starches, oligosaccharides, coloring agents, binding agents, stabilizing agents, flavor enhancers, flavoring agents, fragrance enhancers, vitamins, minerals, antioxidants, essential oils, pH regulators, dietary fibers, gluten, and mixtures thereof. Non-limiting examples of flavoring agents are animal meat flavor, an animal meat oil, spice extracts, spice oils, natural smoke solutions, natural smoke extracts, yeast extract, and shiitake extract. Additional flavoring agents may include onion flavor, garlic flavor, or herb flavors. Herbs that may be added include basil, celery leaves, chervil, chives, cilantro, parsley, oregano, tarragon, and thyme. Non-limiting examples of flavor enhancers include glucose, fructose, ribose, arabinose, glucose-6-phosphate, fructose-6-phosphate, fructose-1,6-diphosphate, inositol, maltose, sucrose, maltodextrin, glycogen, sugars associated with nucleotides, molasses, animal meat flavor, an animal meat oil, spice extracts, spice oils, natural smoke solutions, natural smoke extracts, yeast extract, and shiitake extract. Additional flavoring agents may include onion flavor, garlic flavor, or herb flavors. Herbs that may be added include basil, celery leaves, chervil, chives, cilantro, parsley, oregano, tarragon, and thyme or mixtures thereof. Non-limiting examples of dietary fiber component may include vegetable fibers from carrots, bamboo, peas, broccoli, potatoes, sweet potatoes, corn, whole grains, alfalfa, collard greens, celery, celery root, parsley, cabbage, squash, green beans, common beans, black beans, red beans, white beans, beets, cauliflower, nuts, apple peels, oats, wheat or plantain, or mixtures thereof. Non-limiting examples of vitamins that can be used include Vitamins A, C, and E. Non-limiting examples of minerals that may be added include the salts of aluminum, ammonium, calcium, magnesium, and potassium.

### G. High Moisture Meat Analogs

As previously mentioned, the current disclosure encompasses meat analogs comprising oleogels. The meat analogs may be of different kinds as described in A and may be manufactured by different methods known in the art. An exemplary meat analog envisaged in the current disclosure is a high moisture meat analog (HMMA) made from HMEC procedure and comprising an oleogel. High moisture meat analogs are typically produced have high moisture content. In some aspects, of the current disclosure the moisture content of the HMMA may be about 40%, or about 45%, or about 50% or about 55%, or about 60%, or about 65%, or about 70%, or about 75% or about 80% by weight of the HMMA. The HMMA further comprises a protein composition, non-limiting examples of which are provided in Section C. The HMMA further comprises an oleogel composition, non-limiting components of which are provided in Sections D and E. In some aspect of the current disclosure, the HMMA further comprises optional ingredients non-limiting examples of which are provided in Section F.

In some aspect of the current disclosure, the protein composition optionally combined with other ingredients, non-limiting examples of which are listed in Section F may be subjected to prior processing before the addition of the oleogel, to form a precursor meat analog (pre-MA). Non-limiting examples of prior processing may be mixing, blending, extrusion, forming extrusion, heating, pressurized heating, and cooking. In some aspects, the pre-MA may be a texturized vegetable protein (TVP). In some aspect of the current disclosure, the protein composition optionally combined with other ingredients may be subjected to a high moisture extrusion process prior to addition of the oleogel, to form a precursor-HMMA (pre-HMMA). The term pre-HMMA as used in the current disclosure comprises a protein composition, moisture and optionally one or more additional ingredients that have together been subject to at least one extrusion process, but without an oleogel. The pre-HMMA may then be mixed with an oleogel to form a meat analog comprising weight ratios of about 60% pre-HMMA to about 40% oleogel, or about 65% pre-HMMA to about 35% oleogel, or about 70% pre-HMMA to about 30% oleogel, or about 75% pre-HMMA to about 25% oleogel, or about 80% pre-HMMA to about 20% oleogel. In some aspects, of the current disclosure, the oleogel composition may be mixed with pre-HMMA prior to additional extrusion steps. In some aspect of the current disclosure, the pre-HMMA may be mixed with the oleogel composition in-line during an extrusion step. In some aspect of the current disclosure, the pre-HMMA may be mixed to the oleogel composition prior to the cooling die step. In some aspect of the current disclosure, the pre-HMMA may be mixed to the oleogel composition at the cooling step using a static mixer. In some aspects, the oleogel may be injected into the pre-HMMA. In some aspects, the oleogel may be integrated with the pre-HMMA using a cold extrusion process. In some aspects, of the current disclosure the pre-HMMA may be mixed with the oleogel composition without a further extrusion step. The resulting HMMA may comprise a non-homogenous dispersion of fat providing a marbled meat-like texture.

In some aspects, the oleogel in the HMMA maintains a gel, jelly like or solid structure thus giving the HMMA a marbled appearance. The term “marbled” as used here describes an appearance and texture of meat analogs wherein the meat analog has a non-homogenous distribution of lipids. Lipids and/or oleogels are visible as flecks, spots, and/or channels in the meat analog, like animal meat.

### H. Food Compositions and Products

In some aspects, the current disclosure also encompasses food compositions and products comprising the meat analogs, oleogel compositions and composites as disclosed herein. Food compositions into which the meat analogs, oleogel compositions and composites of the current disclosure may be included may be final edible products ready to be consumed by human beings and/or animals. They may comprise various additional components or ingredients, each imparting a desired feature or characteristic to the products, such as nutrition, flavor, appearance, taste, and texture. In some aspects, the meat analogs, oleogel compositions and composites disclosed herein may also be incorporated into intermediate products that may be processed further before consumption.

Food compositions contemplated herein include meat, poultry and seafood analogs comprising as a component the disclosed compositions. Non-limiting examples of compositions comprising the meat analogs disclosed herein include compositions mimicking ground meat, meatloaf mix, steaks, pinwheels, sausages, salami, jerky, bacon, pork boneless rib meat, chicken cutlets, tenders, drumsticks, or hams, soups or stews. Non-limiting examples of poultry analog compositions include vegan chicken, mock chicken, vegan turkey, and compositions mimicking nuggets, cutlets, breasts, slices or strips sourced from chicken, quail, duck, ostrich, turkey, bantam, or geese. Non-limiting examples of seafood analog include fish, clams, oysters, mussels, lobsters, shrimp, crab, echinoderms analogs. The food compositions described herein may be formulated to mimic any real meat, poultry, or seafood product, such as ground meat, ground meat patties, ground meat meatballs, meat steaks, meat sausage, meat jerky strips, ground chicken, poultry slices, fish fillets, seafood cutlets, seafood pies, salmon burgers, fish sticks, crab cakes, fish burgers, fish cakes, sushi, chowder, bisques, rolls and seafood stews or any combination thereof. In some aspects, the food compositions described herein may be formed as any such product formed from real beef, poultry, or seafood. The present disclosure expressly contemplates, for example, plant-based food compositions in the form of plant-based beef, which may take the form of a ground beef patty or slider, a ground beef meatball, a beef sausage or hot dog, a cut of beef, corned beef, or a dried beef strip. The meat alternative formulation described herein may alternatively be prepared in the form taken by other real meat products such as meat (beef, chicken, or turkey) nuggets or strips, meat loaf or meat cake forms, canned seasoned meat, sliced meat, sausage of any size, or processed meats such as salami, bologna, luncheon meat and the like. The meat alternative formulation, after cooking, may provide the color, the flavor, and the texture of cooked meat which is pleasurable and palatable to the consumer. The meat analogs, oleogel compositions and composites compositions may comprise a plant-based meat-like base combined with microbial cells containing heme-containing protein to impart the color and flavor of a real animal, poultry, meat or seafood to the meat analog compositions.

In some aspects, the meat analogs, oleogel compositions and composites may also be incorporated in gravies, sauces, purees, broths, soups, pastes, spreads and similar foods that could benefit in flavor, texture or color by addition of the meat analogs, oleogels or oleogel composites as disclosed herein. In some aspects, the compositions may also be incorporated into plant-based cheese and other diary mimicking products.

### II. Method of Making

In some aspects, the current disclosure encompasses methods of making a meat analog comprising an oleogel, compositions for which are provided in Section I of the detailed description above. These methods encompass novel ways to provide a meat-like non-homogenous distribution of lipids in the meat analog also referred to as marbling in the art.

### A. Equipment

In some aspects, of the current disclosure, the ingredients for forming the meat analog envisaged here comprising at least an oleogel composition and at least any one or combinations of vegetarian protein composition, plant-derived protein formulation, pre-HMMA, HMMA, TVP or any pre-formed meat analog (pre-MA) may be mixed using one or more of mixing and/or extrusion equipment known in the art. Non-limiting examples of these mixing equipment include blenders, conical drums, mixing drums, belt blenders, ribbon blender, Hobart mixers, mechanical kneading equipment, extruders, high shear extruders, forming extruders, low shear extruders, piston-type extruders, screw-type extruders, and combinations thereof.

### B. Extruders

In some aspects, the current disclosure comprises subjecting some or all ingredients to one or more extrusion processes. As used in the current disclosure, an “extrusion” refers to a process in which a material is pushed under compressive stresses through a deformation control element such as a die to form a product. The process of extrusion is usually accomplished by using equipment referred to in the art as an extruder. The current disclosure encompasses use of extruders with a wide range of configurations and attachments for manufacturing of the meat analog compositions disclosed. An extruder typically comprises a feed assembly, an optional preconditioner, an extruder barrel, barrel head, sleeve, extruder screw, extruder drive, extrusion discharge or die system, heating/cooling system, safety and control systems, and a knife assembly. Additional attachments comprising one or more additional feed assemblies, die assemblies, heating units, monitors or any other attachment known in the art may be added based on the requirement of the application. The extruder as used herein may comprise a single screw extruder or a twin-screw extruder, or a combination thereof. It may be a single screw “wet” extruder (with or without the preconditioner), single screw “dry” extruder (with or without the preconditioner), single-screw interrupted flight extruder (with or without a preconditioner), and twin-screw extruder (with or without a preconditioner). The current disclosure encompasses use of extruders with a wide range of screw diameters, lengths, designs and configurations known in the art that may be used in the manufacturing of the compositions provided.

In some aspects, of the current disclosure, the extruder is any of a wide variety of twin-screw extruders including equipment with widely different processing and mechanical characteristics. The screw in the twin-screw extruder may be co-rotating and counter rotating. The screw position may be an intermeshing screw or a non-intermeshing screw. Thus, any one or more of non-intermeshed and corotating, non-intermeshed and counterrotating, intermeshed and corotating, intermeshed and counterrotating twin screw extruders may be used for practicing the methods provided herein. In some aspects, of the current disclosure, the extruder may comprise a thermal twin-screw design comprising barrel stem injection capabilities, vent and mid barrel valves and frame. In some aspects, the extruder may be a bench top twin-screw extruder. In some aspects, the extruder may be a laboratory scale extruder. In some aspects, the extruder may be a pilot processing or production scale extruder. In some aspects, the extruder may be a 16 mm twin screw extruder. In some aspects, the extruder may be a 24 mm twin screw.

In some aspects, the current disclosure also encompasses cold extruders, or an extruder operationally linked to a cold extruder. As used herein, cold extruders are used to gently mix and shape dough without the elevated temperatures typically utilized during the extrusion process. The elevated cooking temperatures typically utilized in extrusion processes can lead to discoloration of the HMMA and can also result in melting of the oleogels. In a cold extrusion process temperatures up to, but not exceeding, 100° C. may be utilized. In some aspects, a cold extruder is used to mix the oleogel with the remaining ingredients. In some aspects, a cold extruder is used to mix the pre-HMMA (or a previously extruded dough) with the oleogel. As envisaged herein, the cold extruder can be operationally linked to a high temperature extruder, such that the extruded HMMA/pre-HMMA formulation is directly passed through a cold extruder, where it is mixed with an oleogel or an oleogel composite. In some aspects, the cold extruder may be used as a stand-alone equipment, wherein the pre-HMMA is mixed with the oleogel or oleogel composite. In some aspects, the temperature of operation of the cold extruder depends on the composition of the oleogel or the oleogel composite. For example, the cold extruder may be operated at a temperature ranging from sub-zero to less than 100° C. In some aspects, the cold extruder may be operated at less than 0° C., or less than 5° C., or less than 10° C., or less than 20° C., or less than 30° C., or less than 40° C., or less than 50° C., or less than 60° C., or less than 70° C., or less than 80° C., or less than 90° C. In one aspect, the cold extrusion process is performed at a temperature or range of temperatures that are less than the melting point of one or more components of the oleogel.

### C. Feed Assemblies and Methods of Adding Ingredients to Extruders

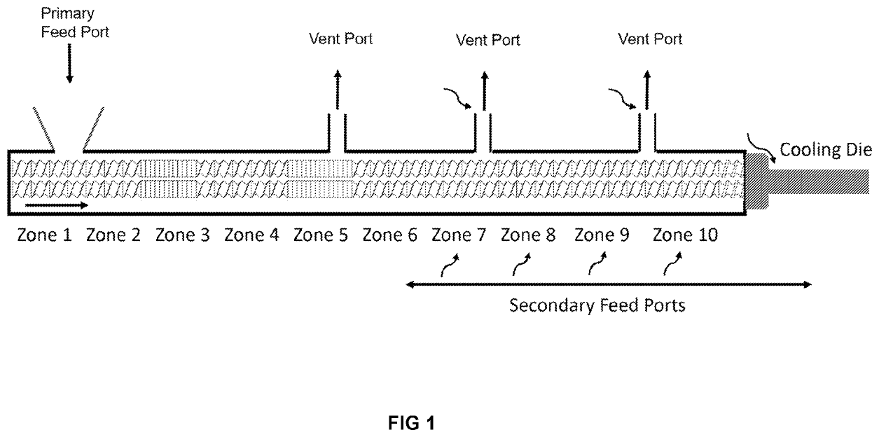

In an exemplary aspect of the current disclosure, the extruder may be a co-rotating twin screw thermal extruder with a cooling die assembly. For the sake of better reference, the co-rotating twin screw extruder may be divided into functional zones 1-10 (zonal positions and numbers may change based on the extruder type) as shown in FIG. 1. Zones 1 and 2 are typically dedicated to initial feeding and conveying. zone 3 typically comprises mixing and conveying features with a water in-take mechanism. Zones 4-10 typically support further mixing and conveying and may contain one or more vent ports. In case of hot melt extruders, the extruder may further comprise heating and cooling equipment. Two or more of zones 5-10 may be combined depending on the type and length of the extruder. A typical extruder has a primary feed assembly located in zone 1. In some aspects, of the current disclosure, additional feed assemblies may be added to the extruder in any one of the zones. In some aspects, of the disclosure, additional feed assemblies may be placed in zone 5, or zone 6, or zone 7, or zone 8, or zone 9, or zone 10 or prior to the cooling dye or at the cooling dye or any combination thereof. In some aspects, the feed assemblies may be added to zone 8, or zone 9, or zone 10, or just prior to the cooling dye, or at the cooling die or combinations thereof. In some aspects, the vent ports may also be used to place feed assemblies.

In some aspects, of the current disclosure the ingredients for forming the meat analog may be added through a single feed assembly. In some aspects, of the current disclosure the ingredients may be added through separate feed assemblies. In some aspects, the ingredients may be added sequentially though the same or different feed assemblies. In some aspects, the ingredients may be added simultaneously through the same or different feed assemblies. The feed rate as envisaged in this disclosure can vary widely depending on the ingredient and the screw speed. Methods of calculating the possible feed rates are well known in the art and may depend on screw speed, torque limit of the screws and gearbox, screw design, viscosity, moisture content, head pressure, backflow, barrel length etc. In some aspects, of the current disclosure an acceptable range of feed rate is maintained that depends of the ratio of the feed rate (Q) and the screw speed (N) that in turn depends of torque limit of the screws and gearbox, screw design, viscosity, moisture content, head pressure, backflow, barrel length etc. In some aspects, the feed rate may be constant. In some aspects, the feed rate may vary. In some aspects, the ingredients may be starve fed. In some aspects, the ingredients may be flood fed. In some aspects, combinations of starve and flood feeding may be used at different feed ports. In some aspects, facilitated feeding may be used. Facilitated feeding may be achieved by any known method of art including but not limited to using high pressure pumps, gear pumps, screens, mixers, static mixers, pushers, heaters, or combinations thereof. In some aspects, the ingredients may be diluted with oils or aqueous elements to facilitate feeding.

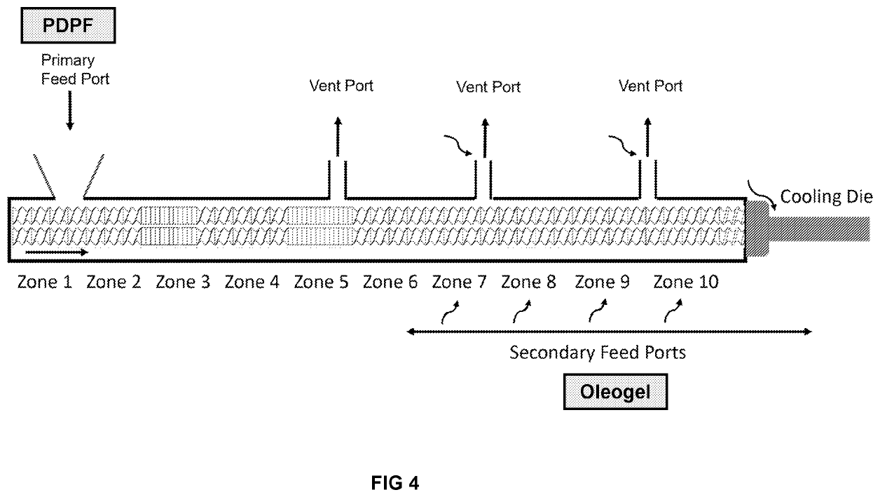

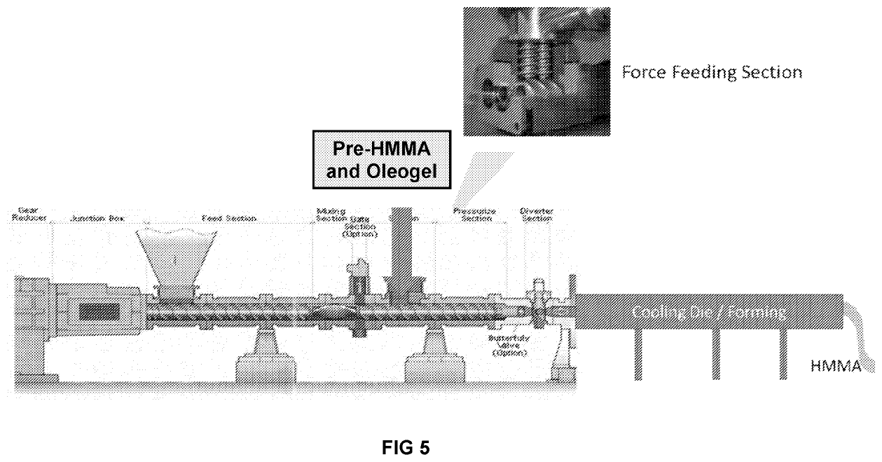

In an exemplary aspect of the current disclosure, the dry protein formulation and other optional ingredients may be added through the standard feed assembly along with a molten oleogel composition that is added dropwise to it. In some aspect of the current disclosure the protein composition and optionally additional ingredients may be added through the standard feed assembly and the oleogel and optionally other ingredients may be added through a second feed assembly attachment. In some aspect additional feed assemblies may be placed in zone 2, or zone 5, or zone 6, or zone 7, or zone 8, or zone 9, or zone 10, or prior to the cooling dye or at the cooling die or any combination thereof. In some exemplary aspects of the current disclosure the oleogel composition may be fed through a force-feeding section after the mixing region in zones 7, or 8, or 9, or 10 (as shown in FIG. 4 and FIG. 5). In some exemplary aspects of the current disclosure, the oleogel may be added though the vent ports located in zone 8, or zone 9, or zone 10 or combination thereof. In some exemplary aspects, the oleogel may be fed just prior to the cooling die. In some exemplary aspects, using static mixers and additional feed assemblies, the oleogel may be fed at or near the cooling die. In some aspect of the current disclosure the protein composition and optionally additional ingredients and the oleogel composition may added through the same feed assembly that is not the standard feed assembly.

In some aspects, of the current disclosure, the protein composition may have undergone previous processing prior to being fed into the extruder. Non-limiting examples of prior processing may be mincing, blending, extrusion, forming extrusion, heating, high moisture extrusion, pressurized heating and cooking. The resulting product is referred herein as a precursor meat analog (pre-MA) including but not limited to a precursor-HMMA or a TVP. In some aspects, of this disclosure, the pre-HMMA or pre-MA or TVP may be mixed with the oleogel and the reintroduced into an extruder. In some aspects, of this disclosure, the pre-HMMA or pre-MA or TVP may be mixed with the oleogel using any of the mixing equipment known in the art including but not limited blenders, conical drums, mixing drums, belt blenders, ribbon blender, Hobart mixers, mechanical kneading equipment, extruders, high shear extruders, forming extruders and low shear extruders, piston-type extruders, screw-type extruders and combinations thereof, prior to introduction into a co-rotating twin-screw extruder. In some aspects, of the disclosure the mixture may then be introduced into an extruder through any of the standard or additional feed assemblies optionally located in one or more of zones 5-10 of the extruder. In some aspects, of the current disclosure, the pre-MA or pre-HMMA or TVA and the oleogel may be introduced into a co-rotating twin-screw extruder from different feed ports. In some aspects, of the disclosure the premixed or individually added pre-MA and oleogel may undergo heating in the extruder. In some aspects, of the disclosure, the premixed or individually added pre-MA and oleogel may undergo a high moisture extrusion in the extruder. In some aspects, of the disclosure the premixed or individually added pre-MA and oleogel may undergo a forming event in the extruder with no additional heating and/or cooling. In some aspects, of the disclosure the premixed or individually added pre-MA and oleogel may undergo a forming event in the extruder with additional heating and/or cooling.

In some aspects, the oleogel may be processed to comprise added polysaccharides, oligosaccharides, starches, dietary fibers, glycogen, pectin, maltodextrin, inulin, thickening agents, and combinations thereof to form a Oleogel-composite prior to addition to the extruder. The oleogel may be mixed with these ingredients by any of the mixing techniques known in the art. Non-limiting examples of equipment that may be used include blenders, conical drums, mixing drums, belt blenders, ribbon blender, Hobart mixers, mechanical kneading equipment, extruders, high shear extruders, forming extruders and low shear extruders, piston-type extruders, screw-type extruders, and combinations thereof. In some aspects, the current disclosure encompasses methods of introducing these oleogel-composites into an extruder for example a twin-screw extruder. In some aspects, the oleogel-composite may be added through any one of the additional feed assemblies. In some exemplary aspects of the current disclosure the oleogel-composite is introduced at the vent port or just prior to the cooling die. In some exemplary aspects a pre-HMMA or pre-MA or TVA may be added through a feed assembly prior to the vent port and the starch-composite added at the vent-port feed assembly prior to the cooling die.

In some aspects, the pre-HMMA, or pre-MA or TVA or oleogel-composites or combinations thereof may need facilitated feeding into the extruder for instance at low-pressure points like vent ports and secondary feed assemblies. This may be achieved by any method known in the art including external energy input, high pressure pumps, gear pumps, screens, mixers, static mixers, pushers, heaters, dilution, or combinations thereof.

### D. Die Assembly

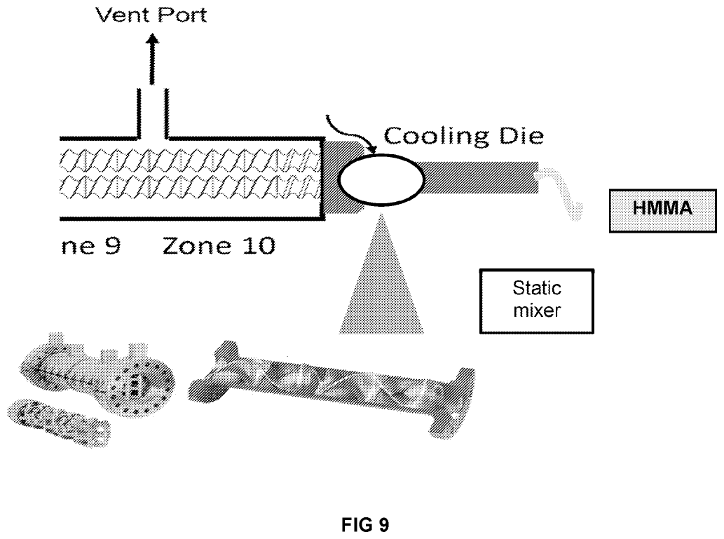

A die assembly is typically attached to the extruder in an arrangement that permits the contents to flow from the extruder exit port into a die. In some aspects, the die assembly may be responsible for forming desired product shape and cooling (FIGS. 1 and 9). The die assembly may also affect the choice of parameters and impacts the output/degree of fill, specific mechanical energy, cooling rate and material transformation. The die may be single or multichannel. In some aspects, of the disclosure, the width of the die aperture(s) may be set so that the extrudate resembles from a cubic chunk where, widening the width of the die aperture(s) decreases the cubic chunk-like nature of the extrudate and increases the filet-like nature of the extrudate. In some aspects, the width of the die aperture(s) is/are set to a width of from about 20 millimeters to about 120 millimeters, or from about 60-80 millimeters. The height dimension of the die aperture(s) may be set to provide the desired thickness of the extrudate. The height of the aperture(s) may be set to provide a very thin extrudate or a thick extrudate. In some aspects, of the current disclosure, the height of the die aperture(s) may be set to from about 1 millimeter to about 25 millimeters, or from about 5 millimeters to about 15 millimeters. In some aspects, the die aperture(s) may be round. The diameter of the die aperture(s) may be set to provide the desired thickness of the extrudate. The diameter of the aperture(s) may be set to provide a very thin extrudate or a thick extrudate. In some aspects, the diameter of the die aperture(s) may be set to from about 1 millimeter to about 30 millimeters, or from about 8 millimeters to about 16 millimeters. In some aspects, the die maybe a long die. In some aspects, the die may be a short die. In some aspects, the length of the die may be from about 200 to about 500 millimeters, or from about 300 to about 400 millimeters. In some aspects, the die aperture may be a slit. In some aspect the die may be a sheet die.

In some aspects, the die may be a cooling die. In some aspects, the cooling die may comprise one or more cooling lines integrated within the cooling die and connected to the one or more cooling devices. In some aspects, the one or more cooling devices may include a fluid reservoir. The cooling devices may direct a liquid (e.g., water, R134-a, and/or another refrigerant) through the cooling lines of the cooling die to remove heat energy from the cooling die. The cooling die may include a temperature sensor to sense the temperature of the cooling die. The one or more cooling devices may adjust a fluid flow rate and/or a fluid temperature in reply to and/or based on feedback received from the temperature sensor. In an embodiment, multiple temperature sensors may be positioned along a flow path.

In some aspects, the cooling die may further comprise a secondary feed port operable to introduce ingredients comprising one or more of oleogels, oleogel-composites into the melt or cooled HMMA, pre-HMMA, pre-MA or TVA. In some aspects, the secondary feed port may require facilitated feeding equipment including but not restricted to, one or more of high-pressure pumps, gear pumps, screens, mixers, static mixers, pushers, heaters, dilution equipment, coolers, or any combinations thereof.

In some aspects, the die is a coextrusion die to introduce the oleogel as the melt as it is leaving the barrel.

In some aspects, the strands or strings of extruded product may spontaneously break into smaller pieces. In some aspects of the invention, the extruder or die equipment may be fitted with a cutting mechanism. In other embodiments, the extruded product is cut with a knife or other cutting device, such as an air blow off, a wire knife, a metal guillotine, rotary cutter, knock-off or a flicker wheel. In some embodiments, the cutting device features a reciprocating or circular motion.

### E. Running Parameters

In some aspects, of the current disclosure, the co-rotating twin screw extruder may be run using a range of parameters depending on product requirements. In some aspects, the current disclosure encompasses method of production of meat analogs with oleogel, using any of the combination of functional parameters known in the art. The ranges provided herein are exemplary and non-limiting. In some aspects, the extruder may have an in-barrel content moisture ranging from 20-100%. In some aspects, the in-barrel moisture content may vary between 40-80%. In some exemplary aspects, the in-barrel moisture content may vary between 50-70%. In some aspects, the screw speed may vary from 0-1000 rpm. In some aspects, the screw speed may vary between 100-900 rpm. In some aspects, the screw speed may vary between 200-800 rpm. In some aspects, the screw speed may vary between 300-700 rpm. In some aspects, the screw speed may vary between 400-600 rpm. In some exemplary aspects the screw speed may vary between 500-800 rpm.

In some aspects, the different zones in an extruder can operate at different temperatures. As used herein, the term heating zone is used to indicate a zone where the internal temperature of the extruder is higher than the sample temperature. As used herein, the term cooling zone is used to indicate a zone wherein the internal temperature of the extruder is lower than the sample temperature. The zonal temperatures may vary depending on the product, production requirements, the specific zone, and the heating and cooling capabilities. The temperature in the heating zones may range from RT to >250° C. In some aspects, the temperature of any zone of the extruder can be manipulated depending on the process requirement and the nature of the desired product. In some aspects, the temperature in the one or more heating zones can range from about 30° C. to about 40° C., or about 40° C. to about 50° C., or about 50° C. to about 60° C., or about 60° C. to about 70° C., or about 70° C. to about 80° C., or about 80° C. to about 90° C., or about 90° C. to about 100° C., or about 100° C. to about 150° C., or about 150° C. to about 200° C., or about 200° C. to about 300° C. The temperatures in the cooling sections may vary from 0° C. to >250° C. In some aspects, the temperature in the one or more cooling zones can range from about sub-zero to about 5° C., or about 5° C. to about 10° C., or about 10° C. to about 20° C., or about 20° C. to about 30° C., or about 30° C. to about 40° C., or about 40° C. to about 50° C., or about 50° C. to about 60° C., or about 60° C. to about 70° C., or about 70° C. to about 80° C., or about 80° C. to about 90° C., or about 90° C. to about 100° C. In some aspects of the disclosure, the specific mechanical energy may vary from 10-80 Whr/Kg or more typically between 50-80 Whr/Kg. The pump setting for pumping water into the twin-blade extruder may vary based on the moisture requirement of the product. Table 1 provides an exemplary set-up for a Thermo Fischer twin-screw extruder.

In some aspects, the cold extruder may be operated at less than 0° C., or less than 5° C., or less than 10° C., or less than 20° C., or less than 30° C., or less than 40° C., or less than 50° C., or less than 60° C., or less than 70° C., or less than 80° C., or less than 90° C. either in-line or operationally linked to another extruder or as a standalone instrument as provided herein.

TABLE 1
Example working parameters and ranges for a co-rotating
twin screw extruder from Thermo Fischer (all values are
exemplary and may change based on product requirement)

| Parameter | Value/range | |
|---|---|---|
| Moisture | 50-80% | |
| Screw speed | 0-1000 | rpm |
| Zonal temperature | Zone 2 - 40° | C. |
| | Zone 3 - 60° | C. |
| | Zone 4 - 100° | C. |
| | Zone 5 - 120° | C. |
| | Zone 6 - 140° | C. |
| | Zone 7 - 150° | C. |
| | Zone 8 - 160° | C. |
| | Die - 160° | C. |
| In barrel product temperature | >140-150 | |
| Cooling zone | 17° | C. |
| Feed rate constant | 0.5-25 | kg/h |
| Specific mechanical energy | 50-80 | Whr/kg |

Unless defined otherwise, all technical and scientific terms used herein have the meaning commonly understood by a person skilled in the art to which this invention belongs. The following references provide one of skill with a general definition of many of the terms used in this invention:

When introducing elements of the present disclosure or the preferred aspects(s) thereof, the articles “a”, “an”, “the” and “said” are intended to mean that there are one or more of the elements. The terms “comprising”, “including” and “having” are intended to be inclusive and mean that there may be additional elements other than the listed elements.

Detailed embodiments of products, devices and methods are disclosed herein. However, it is to be understood that the disclosed embodiments are merely exemplary of the devices and methods, which may be embodied in various forms. Therefore, specific functional details disclosed herein are not to be interpreted as limiting, but merely as a basis for the claims as a representative example for teaching one skilled in the art to variously employ the present disclosure.

As used herein, the terms “about” and “approximately” designate that a value is within a statistically meaningful range. Such a range can be typically within 20%, more typically still within 10%, and even more typically within 5% of a given value or range. The allowable variation encompassed by the terms “about” and “approximately” depends on the particular system under study and can be readily appreciated by one of ordinary skill in the art.

As used herein, the term “w/w” designates the phrase “by weight,” “weight percent,” or “wt. %,” and is used to describe the concentration of a particular substance in a mixture or solution.

As used herein, the term “ml/kg” designates milliliters of composition per kilogram of formula weight.

### EXAMPLES

All patents and publications mentioned in the specification are indicative of the levels of those skilled in the art to which the present disclosure pertains. All patents and publications are herein incorporated by reference to the same extent as if each individual publication was specifically and individually indicated to be incorporated by reference.

The publications discussed throughout are provided solely for their disclosure before the filing date of the present application. Nothing herein is to be construed as an admission that the invention is not entitled to antedate such disclosure by virtue of prior invention.

The following examples are included to demonstrate the disclosure. It should be appreciated by those of skill in the art that the techniques disclosed in the following examples represent techniques discovered by the inventors to function well in the practice of the disclosure. Those of skill in the art should, however, in light of the present disclosure, appreciate that many changes could be made in the disclosure and still obtain a like or similar result without departing from the spirit and scope of the disclosure, therefore all matter set forth is to be interpreted as illustrative and not in a limiting sense.

### Example 1. Making of Ethylcellulose Oleogel

In this exemplary embodiment, an oleogel was made using standard procedure using the following ingredients:
5% Ethylcellulose 45 cP (ETHOCEL®, Dow Chemical Co.)
38% Monoacylglycerol
57% Canola oil

Briefly, the ingredients were heated above the glass transition temperature of ethylcellulose with mixing (about 130-160° C.) to ensure full solubilization of the polymer in oil. The solution was allowed to cool to room temperature. The resulting gel was suitably clear, uniform and elastic.

### Example 2. Extrusion Protocol 1: Plant Derived Protein Formulations and Oleogel Introduced from the Same Feed Port

This example provides one of multiple method that were practiced for making a meat analog comprising an oleogel, such that the meat analog has a non-homogenous distribution of lipids providing a meat like appearance and texture. To test the feasibility of using oleogels in meat analogs as a replacement for other fat sources, a comparison was made between HMMA comprising sunflower oil and HMMA comprising oleogels.

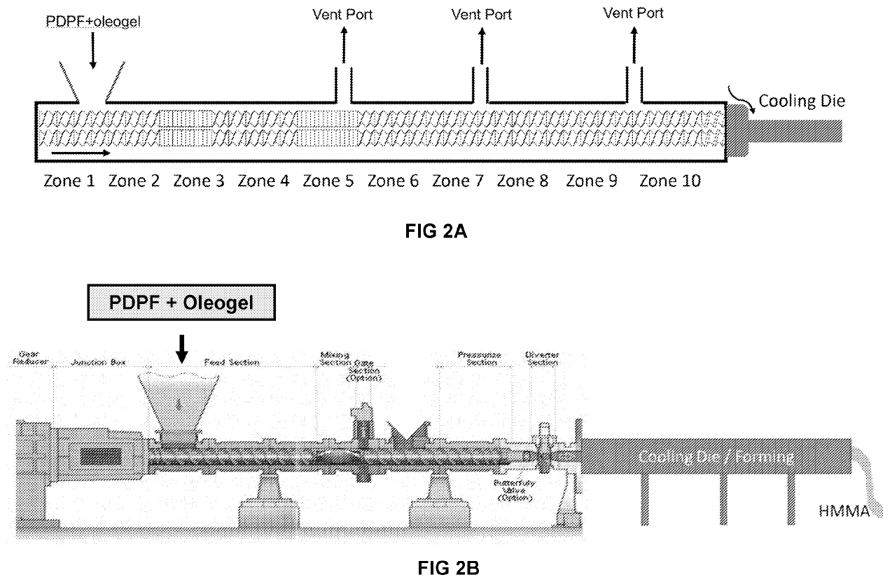

To achieve this, a mixture of pea protein concentrate (98 wt %) and gluten powder (2 wt %) was placed in a dry-solids feeder of a Thermo Fischer co-rotating twin blade extruder (primary feeder assembly—zone 1). The dry solids were fed into the extruder at Zone 1 (FIG. 2A and FIG. 2B) using a setpoint of the screw running the feeder at 22% of the maximum setting and an actual feed rate of 1.050 kg/hr. Ethylcellulose oleogel (5% ethylcellulose 45 cP; 38% monoacylglycerols; 57% canola oil) was incorporated into the dry solid dropwise at the dry solids inlet feed (primary feeder assembly—zone 1) to a final weight of about 8%.

As the screw turned and more dry ingredients were fed, water was pumped into Zone 3 of the extruder by a peristaltic pump at the flow rate of 47 mL/hr, which corresponds to a flow rate of 1.029 kg/hr. The process of feeding water was timed about 5-10 seconds after the starting of the feeder to avoid locking up the extruder. The mixture was passed through the twin-screw extruder at a rotational speed of 315 rpm and zonal temperatures during operation as listed in Table 2.

TABLE 2
Temperature at each zone of the twin-screw extruder

| Zone 2 | Zone 3 | Zone 4 | Zone 5 | Zone 6 | Zone 7 | Zone 8 | Die |
|---|---|---|---|---|---|---|---|
| 40° C. | 60° C. | 100° C. | 120° C. | 140° C. | 150° C. | 160° C. | 160° C. |

In a control experiment, sunflower oil was used in place of the ethylcellulose oleogel. As with the oleogel, a mixture of pea protein concentrate (98 wt %) and gluten powder (2 wt %) was fed into the extruder at Zone 1 using a setpoint of 22% and a feed rate of 1.050 kg/hr. Sunflower oil was incorporated into the dry solid dropwise at the feed inlet as the dry solids were fed. As the screw turned and more dry ingredients were fed, water was pumped into Zone 3 of the extruder by a peristaltic pump at the flow rate of 47 mL/hr, which corresponds to a flow rate of 1.029 kg/hr. The mixture was passed through the twin-screw extruder at a rotational speed of 315 rpm and zonal temperatures as in Table 2. Additionally, a no fat control experiment was run using the same parameters. All parameters used were the same for both the control experiments and the experiment with oleogel.

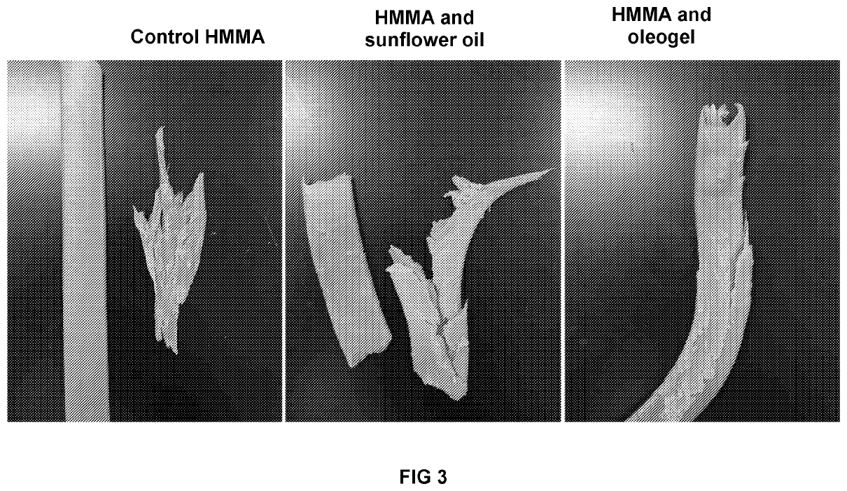

Using the process described, various HMMA were produced and analyzed further. These experimental and control high moisture meat analogs (HMMA) are shown in FIG. 3. The HMMA with incorporated sunflower oil was softer and easier to tear than the HMMA without any extra fat. HMMA with incorporated ethylcellulose oleogel was similarly soft and easy to tear in comparison to HMMA with sunflower oil. The fibrous nature upon tearing was maintained following the addition of sunflower oil or the ethylcellulose oleogel. No obvious marbling was introduced within the structure of the HMMA even though the ethycellulose oleogel is crystalline at room temperature.

### Example 3. Extrusion Protocol 2: Addition of Oleogels at Different Stages of the Extrusion Process

The results in Example 2 demonstrated that oleogels can be used as a replacement for lipids in meat analogs. To further test different ways of incorporation of oleogels into meat analogs to maximize the meat like nature of the final product, multiple tests were designed where oleogels were incorporated at different stages of the extrusion process.

Table 3 shows three formulations of plant-derived protein that may be used in this example. In each of these tests, dry solids comprising any one of the plant-derived protein formulations in Table 2, will be fed into the extruder at Zone 1 using setpoints and feed rate best suited for the formulation. As the screw of the twin blade extruder turns and more dry ingredients are fed, water will be pumped into Zone 3 of the extruder by a peristaltic pump at the flow rate of about 20-80 mL/hr depending on the experiment. The mixture will be passed through the twin-screw extruder at a rotational speed of about 200 rpm to about 315 rpm and zonal temperatures around the temperatures listed in Table 2. Oleogels comprising ethylcelullose (5% ethylcellulose 45 cP; 38% monoacylglycerols; 57% canola oil) will be introduced into the extruder through a feed assembly placed downstream of the standard feed assembly. Depending on the placement, the oleogel may be heated and extruded with the protein formulation, or the protein formulation may be heated and the oleogel added prior to the cooling die or after cooling. In some set-ups the oleogel will be added intermittently or continuously such that final weight of the oleogel is between 5-10%. FIG. 4 provides a schematic representation of the potential placements of the secondary feed assemblies for introducing oleogels into the extruder.

TABLE 3
Plant derived protein formulations (PDPF)

| Formulation # | Protein | Percentage |
|---|---|---|
| 1 | Soy protein isolate | 60% |
| | Soy protein concentrate | 40% |
| 2 | Soy protein isolate | 50% |
| | Soy protein concentrate | 45% |
| | Vital Wheat Gluten | 5% |
| 3 | Pea protein concentrate | 98% |
| | Gluten powder | 2% |

### Example 4. Extrusion Protocol 3: Extrusion of Premixed Preliminary High Moisture Meat Analog (Pre-HMMA) and Ethylcelullose Oleogel

To further modify the different ways of incorporation of oleogels into meat analogs to achieve in non-homogenous meat-like texture, multiple tests were designed and conducted where the form of oleogels and the protein formulation were experimented with. As part of these tests, a precursor-HMMA formed from an initial extrusion process was mixed with an ethyl cellulose oleogel (5% ethylcellulose 45 cP; 38% monoacylglycerols; 57% canola oil) and then introduced into an extruder to form a final product.

### Step 1. Formation of an Extruded and Minced Plant-Derived Protein Formulation (Pre-HMMA)

As with Example 3, a set of three protein formulations listed in Table 3 will be separately tested. Each of the three formulations will first used to form a precursor HMMA (pre-HMMA) using an extrusion step.

For instance, for formulation 3, dry solids will be fed through the standard feeder assembly of a Thermo Fischer co-rotating twin blade extruder at a feed rate of 1.050 kg/hr.

As the screw turns and more dry ingredients are fed, water will be pumped into Zone 3 of the extruder by a peristaltic pump at the flow rate of 47 mL/hr, which corresponds to a flow rate of 1.029 kg/hr. The process of feeding water will be timed about 5-10 seconds after starting the feeder to avoid locking up the extruder. The mixture will be passed through the twin-screw extruder at a rotational speed of 315 rpm and zonal temperature during operation as listed in Table 2.

The resulting pre-HMMA with each of the three compositions will be separately minced and used in the Step 2.

Step 2. Mixing Oleogel Composition with the Pre-HMMA

Once extruded, each of the three minced pre-HMMA will be mixed in separate experiments with ethylcellulose oleogel (5% ethylcellulose 45 cP; 38% monoacylglycerols; 57% canola oil, and optionally TiO₂ or a suitable coloring agent). Different ratios by weight of the pre-HMMA and ethylcellulose oleogel, ranging from about 70% pre-HMMA and about 30% oleogel, or about 80% pre-HMMA and about 20% oleogel, will be mixed in a Hobart mixer with a ground meat attachment. The resulting mixtures will be passed through a meat grinder and compressed to form long strands. The strands will be cut into discrete smaller pieces or pellets.

### Step 3. Extrusion of the Pellets

The resulting pellets can either be introduced at room temperature or frozen and fed through feed assemblies placed at the force-feeding section at zone 7 (FIG. 5) or any one of the vent ports of the extruder prior to the cooling die. The resulting HMMA will be analyzed for marbling effects, texture and tearing capabilities.

### Example 5. HMMA Extrusion Protocol 4: Oleogel Incorporated into Oleogel Composites Prior to Extrusion

So far either molten, room temperature or frozen ethyl cellulose oleogels were mixed directly with protein or precursor meat analog (pre-HMMA) compositions to obtain a meat analog. In the current example, the oleogel was first incorporated into an oleogel-composite prior to addition to a meat analog or protein formulation.

Step 1. Production of Oleogel Composites with Starch

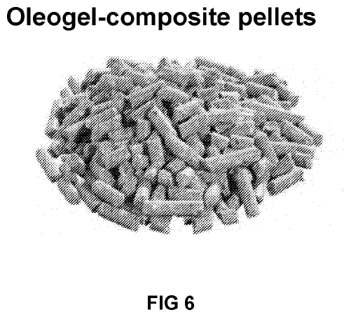

An ethylcellulose oleogel (5% ethylcellulose 45 cP; 38% monoacylglycerols; 57% canola oil), a waxy starch and turmeric as a coloring agent were mixed as shown in using a Hobart mixer with a blade and a ground meat attachment. A low shear mixing was achieved. The resulting mixture was passed through a meat grinder and compressed to form long strands. These strands were cut into pellets and stored for future use (FIG. 6). These pellets will be used in an extrusion step to form a meat analog with the plant protein formulation provided in Table 3, as in the steps outlined below.

### Step 2. Extrusion

In each of these tests, dry solids comprising any one of the plant-derived protein formulations in Table 3, will be fed into the extruder at Zone 1 using setpoints and feed rate best suited for the formulation. As the screw of the twin blade extruder turns and more dry ingredients are fed, water will be pumped into Zone 3 of the extruder by a peristaltic pump at the flow rate of about 20-80 mL/hr depending on the experiment. The mixture will be passed through the twin-screw extruder at a rotational speed of about 200 rpm to about 315 rpm and zonal temperatures around the temperatures listed in Table 2. Pellets comprising encapsulated starch and fat will be added to the extruder from a secondary feed port placed any one of the secondary feed points provided in the schematic in FIG. 1. Both intermittent and continuous feeding will be tested.

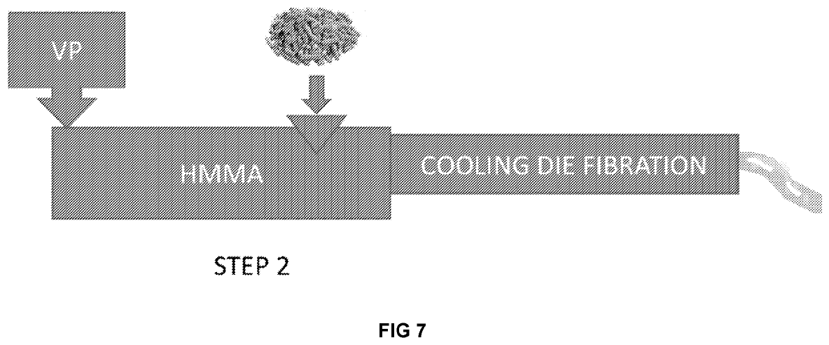

Alternately, for extrusion, pre-HMMA obtained as in step 1 of example 4 will be introduced through a feed assembly placed at any one of the vent port (VP) located between zones 7-10 and the encapsulated starch-extrudable pellets will be introduced through an additional feed assembly placed prior to the cooling die (exemplary configuration shown in FIG. 7).

The resulting HMMA will be analyzed for texture, marbling effect and tear capabilities.

### Example 6. Decoupled Injection

This example is a variation of Example 4. In this example the forming and heating for the meat analog is decoupled with the addition of the oleogel.

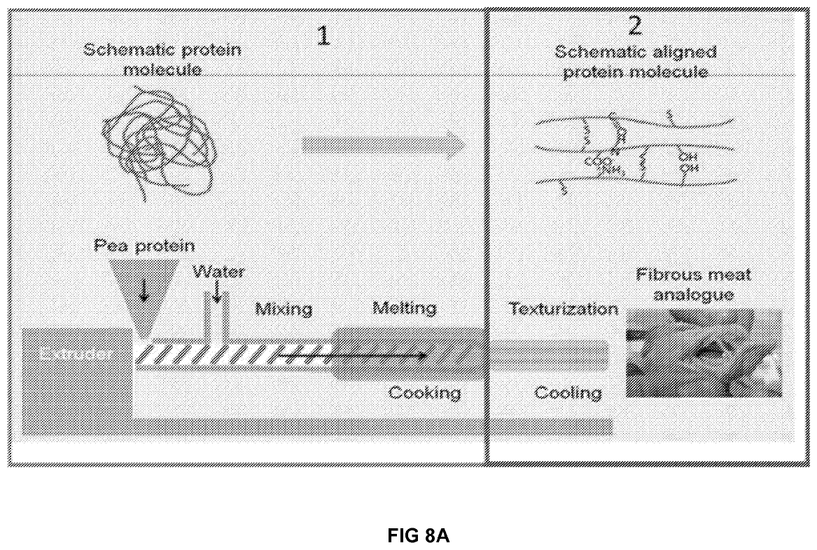

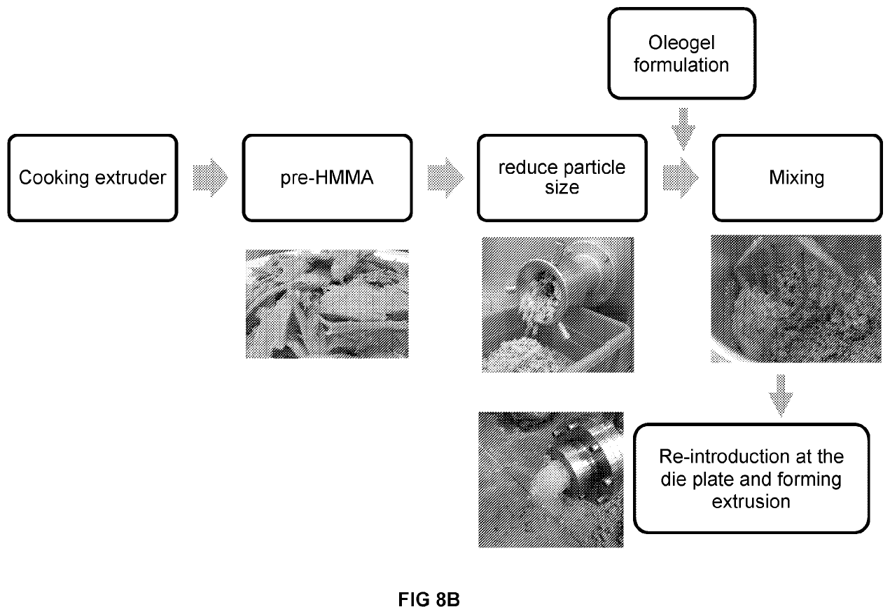

FIG. 8A provides a schematic overview of the decoupled process. The pea-protein formulation as shown in Table 3 was used as the base for forming a pre-HMMA. The ingredients were extruded essentially as in Example 2 and the resulting pre-HMMA was reduced in size using a mincing attachment. The minced pre-HMMA was mixed with the ethyl cellulose oleogel composition (5% ethylcellulose 45 cP; 38% monoacylglycerols; 57% canola oil) using a Hobbart mixer at speed 3. The mixture was introduced at the die plate of the extruder and passed through a long cooling die. Photographs of each step of the process and the resulting meat analog are shown in FIG. 8B.

Other formulations will be tested using the example process provided herein. Briefly, dry solids comprising any one of the plant-derived protein formulations in Table 3, will be added fed into the extruder at Zone 1 using setpoints and feed rate best suited for the formulation. As the screw of the twin blade extruder turns and more dry ingredients are fed, water will be pumped into Zone 3 of the extruder by a peristaltic pump at the flow rate of about 20-80 mL/hr depending on the experiment. The mixture will be passed through the twin-screw extruder at a rotational speed of about 200 rpm to about 315 rpm and zonal temperatures around the temperatures listed in Table 2. A mix of ethylcelullose oleogel, coloring agent (TiO2 or turmeric) and the extruded pre-HMMA will be added just prior to the die plate to obtain desired form. The formation of the pre-HMMA is thus decoupled with the addition of the oleogel. The resulting HMMA will be analyzed for texture, marbling effect and tear capabilities.

### Example 7. Oleogel Fed at the Cooling Die Through a Secondary Feed Assembly

In this example configuration, the oleogel or oleogel composite will be fed into the extruded HMMA at the cooling die using a feed port assembly comprising a static mixer as shown in FIG. 9. The steps for production of the oleogel composites and extrusion will be as in Example 5. Frozen or room temperature oleogel composites or oleogel compositions comprising a coloring agent like TiO₂ or turmeric will be fed through the secondary feed port attached to the cooling die such that the oleogel compositions are incorporated into the extruded melt as it is exiting the extruder.

### Example 8. Combination Protocol Using Twin-Screw (TSE) and a Forming Extruder

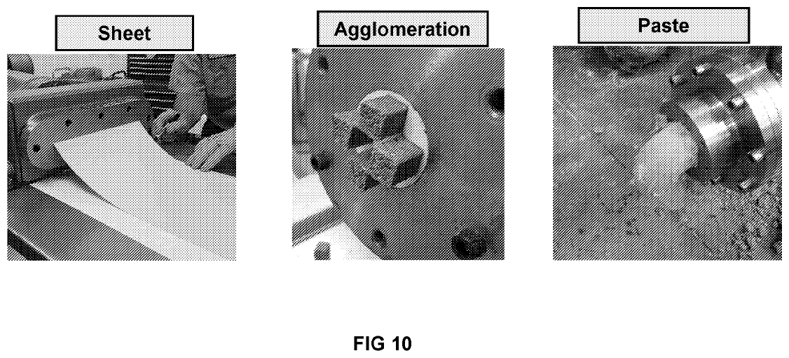

A HMMA produced essentially as in any one of Examples 1-7 may be passed through a second forming extruder with variable die attachments. Some resulting products including sheets, agglomerations or paste are shown in FIG. 10.

### Example 9. HMMA Produced Via Cold Extrusion

A pre-HMMA may be produced as in Example 4. Subsequently, the pre-HMMA may be combined with the oleogel composition as described in Example 1 via the extrusion protocol of Example 2, whereby the temperature of all zones in the extrusion process is maintained at temperatures less than 100° C. The resulting HMMA will be analyzed for marbling effects, texture and tearing capabilities.

What is claimed is:

1. A meat analog composition comprising:
a vegetarian protein composition,
and an oleogel composition,
wherein the meat analog has a non-homogenous dispersion of lipids, providing a marbled texture and/or appearance.

2. The meat analog composition of claim 1, wherein the vegetarian protein composition comprises a plant-derived protein formulation.

3. The meat analog composition of claim 1, wherein the oleogel composition comprises an oleogelator, and a plant-derived lipid.

4. The meat analog composition of claim 3, wherein the oleogelator is selected from a group consisting of a cellulose derivative, xanthan gum, carrageenan, a glycerol, a glyceride, waxes, proteins, sorbitanesters, fatty acids, sterol/sterol ester, lecithin/tocopherols, 12-Hydroxystearic acid, Ricinelaidic acid, and combinations thereof.

5. The meat analog composition of claim 4, wherein the cellulose derivative is selected from a group consisting of methy cellulose, ethylcellulose, methylethyl cellulose, hydroxymethyl cellulose, hydroxyethyl cellulose, hydroxypropyl cellulose, hydroxyethyl ethylcellulose, carboxymethyl cellulose, hydroxypropylmethyl cellulose or cellulose esters or ethers or salts thereof or combinations thereof.

6. The meat analog composition of claim 4, wherein the glycerol is selected from a group consisting of glyceryl caprate, glyceryl caprylate/caprate, glyceryl citrate/lactate/linoleate/oleate, glyceryl cocoate, glyceryl cottonseed oil, glyceryl dioleate, glyceryl dioleste SE, glyceryl disterate, glyceryl distearate SE, glyceryl d/tribehenate, glyceryl lactoesters, glyceryl lactoeleate, glyceryl lactopalmitate/stearate, glyceryl laurate, glyceryl laurate SE, glyceryl linoleate, glyceryl mono/dilaurate, glyceryl mono/dioleate, glyceryl mono/distearate, glyceryl mono/distearate-palmitate, glyceryl oleate, glyceryl oleate SE, glyceryl palmitate, glyceryl palmitate lactate, glyceryl palmitate stearate, glyceryl ricinoleate, glyceryl ricinoleate SE, glyceryl soyate, glyceryl stearate, glyceryl stearate citrate, glyceryl state lactate, and glyceryl stearate SE.

7. The meat analog composition of claim 3 wherein the oleogel composition comprises about 1-60% of the oleogelator by weight.

8. The meat analog composition of claim 3, wherein the oleogelator is ethylcellulose.

9. The meat analog composition of any one of claim 8, wherein the ethylcellulose has a viscosity of about 10 cP to about 100 cP.

10. The meat analog composition of any one of claims 1-9 wherein the oleogel composition comprises about 1-20% by weight ethylcellulose, about 20-50% by weight monoacylglycerol and about 40-75% by weight plant-derived lipid.

11. The meat analog composition of claim 10, wherein the oleogel composition comprises about 5% by weight ethylcellulose 45 cP, about 38% by weight monoacylglycerol, and about 57% by weight plant-derived lipid.

12. The meat analog composition of claim 10, wherein the oleogel composition comprises about 5% by weight ethylcellulose 45 cP, about 19% by weight glyceryl monooleate, about 19% by weight glyceryl monopalmitate or glyceryl monostearate, about 57% by weight plant derived oil.

13. The meat analog composition of claim 3, wherein the plant-derived lipid is selected from a group consisting of soybean oil, safflower oil, rapeseed oil, corn oil, soybean oil, peanut oil, canola oil, palm oil, fractionated palm kernel oil, coconut oil, fractionated coconut oil, and combinations thereof.

14. The meat analog of claim 1, wherein the oleogel composition further comprises one or more starches, one or more dietary fibers, or combinations thereof, mixed with the oleogel composition to form an oleogel-composite, prior to addition to the protein composition.

15. The meat analog composition of claim 14, wherein the source of the one or more starches is selected from a group consisting of corn, potato, rice, wheat, arrowroot, guar gum, locust bean, tapioca, arracacha, buckwheat, banana, barley, cassava, konjac, kudzu, oca, sago, sorghum, sweet potato, taro, yams, fruit, vegetables, tubers, legumes, cereal grains, pseudograins, and combinations thereof.

16. The meat analog composition of claim 14, wherein the one or more dietary fibers are selected from a group consisting of pea fiber, oat fiber, bamboo fiber, rice bran, waxy maize, bean fiber, beet fiber, guar gum, pectin, carrageenan, apple fiber, citrus fiber, carrot fiber, barley fiber, psyllium husk, soy fiber, sesame flour, flaxseed fiber, nuts, garcinia fiber, chicory fiber, and fenugreek fiber.

17. The meat analog composition of claim 14, wherein the oleogel-composite is in a shape selected from pellets, paste, pieces, strands, mince, and combinations thereof prior to addition to the plant-derived protein formulation.

18. The meat analog composition of claim 14, wherein the oleogel-composite comprises about 1% to about 40% of one or more starches, or one or more dietary fibers, or combinations thereof, by weight of the oleogel-composite.

19. The meat analog composition of claim 14, wherein the oleogel-composite comprises, by weight, about 1%, or about 5%, or about 10%, or about 15%, or about 20%, or about 25%, or about 30%, or about 35%, or about 40% of one or more starches, or one or more dietary fibers, or combinations thereof.

20. The meat analog composition of claim 2, wherein the plant-derived protein formulation comprises proteins derived from non-genetically modified or commoditized or hybridized or genetically modified plants selected from a group consisting of soybean (soy), corn, peas, peanuts, almonds, nuts, chickpeas, favas, wheat gluten, and combinations thereof.

21. The meat analog composition of claim 20, wherein the plant-derived protein formulation is selected from a group consisting of soy protein concentrate (SPC), soy protein isolate (SPI), pea protein concentrate, vital wheat gluten, and combinations thereof.

22. The meat analog composition of claim 1, further comprising one or more of emulsifiers, surfactants, sugars, starches, oligosaccharides, coloring agents, binding agents, stabilizing agents, flavor enhancers, flavoring agents, fragrance enhancers, vitamins, minerals, antioxidants, essential oils, pH regulators, dietary fibers, gluten, and combinations thereof.

23. The meat analog of any one of claim 1, wherein the meat analog is a high moisture meat analog.

24. The meat analog composition of claim 23, wherein the vegetarian protein composition and the oleogel composition are mixed prior to an extrusion process.

25. The meat analog composition of claim 23, wherein the high moisture meat analog comprises compositions resulting from the vegetarian protein composition and the oleogel composition being mixed in-line during extrusion.

26. The meat analog composition of any one of claim 23, wherein high moisture meat analog comprises compositions wherein the vegetarian protein composition is mixed with water and extruded to form a precursor HMMA (pre-HMMA).

27. The meat analog composition of claim 26, wherein the pre-HMMA has undergone at least one prior extrusion step.

28. The meat analog composition of claim 26, wherein the pre-HMMA has undergone a high shear cooking process during the at least one prior extrusion step.

29. The meat analog composition of claim 26, wherein the pre-HMMA has undergone a low shear forming process during the at least one prior extrusion step.

30. The meat analog composition of claim 26, wherein the pre-HMMA is in a shape selected from any one of mince, pellets, paste, chunks, patties, and combinations thereof.

31. The meat analog composition of claim 23, wherein the high moisture meat analog comprises the pre-HMMA of claim 26 in combination with the oleogel composition in amounts selected from about 60% by weight pre-HMMA and about 40% by weight oleogel, about 65% by weight pre-HMMA and about 35% by weight oleogel, about 70% by weight pre-HMMA and about 30% by weight oleogel, about 75% by weight pre-HMMA and about 25% by weight oleogel, and about 80% by weight pre-HMMA and about 20% by weight oleogel.

32. The meat analog composition of claim 23, comprising a water content of about 40% to about 70% by weight.

33. An oleogel composition comprising an cellulose derivative, one or more monoacylglycerols, and a plant-derived lipid.

34. The oleogel composition of claim 33, comprising 1-20% by weight cellulose derivative, about 20-50% by weight of one or more monoacylglycerols, and about 40-75% by weight plant-derived lipid.

35. The oleogel composition of claim 33, wherein the cellulose derivative is an ethylcellulose with a viscosity of about 10 cP to about 100 cP.

36. The oleogel composition of claim 33, comprising about 5% by weight ethylcellulose, about 38% by weight of one or more monoacylglycerols, and about 57% by weight plant-derived lipid.

37. The oleogel composition of claim 33, comprising about 5% by weight ethylcellulose 45 cP, about 19% by weight glyceryl monooleate, about 19% by weight glyceryl monopalmitate or glyceryl monostearate, and about by 57% by weight plant derived oil.

38. An oleogel-composite comprising the oleogel composition of claim 34 and additional constituents selected from a group consisting of one or more polysaccharides, oligosaccharides, starches, dietary fibers, glycogen, pectin, maltodextrin, inulin, thickening agents, and any combination thereof.

39. The oleogel-composite of claim 38, wherein the source of the one or more starches is selected from the group consisting of corn, potato, rice, wheat, arrowroot, guar gum, locust bean, tapioca, arracacha, buckwheat, banana, barley, cassava, konjac, kudzu, oca, sago, sorghum, sweet potato, taro, yams, fruit, vegetables, tubers, legumes, cereal grains, pseudograins, and combinations thereof.

40. The oleogel-composite of claim 38, wherein the one or more dietary fibers are selected from the group consisting of pea fiber, oat fiber, bamboo fiber, rice bran, waxy maize, bean fiber, beet fiber, guar gum, pectin, carrageenan, apple fiber, citrus fiber, carrot fiber, barley fiber, psyllium husk, soy fiber, sesame flour, flaxseed fiber, nuts, garcinia fiber, chicory fiber and, and fenugreek fiber.

41. The oleogel-composite of claim 38, comprising about 1-40% of the one or more starches, or the one or more dietary fibers, or combinations thereof by weight.

42. The oleogel-composite of claim 41, wherein the oleogel-composite comprises by weight, about 1%, or about 5%, or about 10%, or about 15%, or about 20%, or about 25%, or about 30%, or about 35%, or about 40% of the one or more starches, or the one or more dietary fibers, or combinations thereof.

43. The oleogel-composite of claim 38, wherein the oleogel composition comprises about 2-7% by weight ethylcellulose, about 35-43% by weight of one or more monoacylglyceryls, and about 51-63% by weight plant-derived lipid.

44. The oleogel-composite of claim 43, wherein the oleogel composition comprises about 5% by weight ethylcellulose 45 cP, about 38% by weight of one or more monoacylglycerols, and about 57% by weight plant-derived lipid by weight.

45. The oleogel-composite of claim 38, wherein the oleogel-composite is in a shape selected form pellets, paste, pieces, strands, mince, and combinations thereof.

46. The oleogel-composite of claim 38, further comprising one or more emulsifiers, surfactants, coloring agents, binding agents, stabilizing agents, flavor enhancers, flavoring agents, fragrance enhancers, pH regulators, and combinations thereof.

47. A high moisture meat analog (HMMA) comprising:
a vegetarian protein composition, and
an oleogel composition comprising:
about 1-10% by weight of the oleogel of ethylcellulose,
about 20-50% by weight of the oleogel of one or more monoacylglycerols selected from glyceryl monooleate, glyceryl monopalmitate and glyceryl monostearate,
and about 40-75% by weight of the oleogel of a plant-derived lipid,
wherein the high moisture meat analog has a non-homogenous dispersion of lipids providing a marbled texture and/or appearance.

48. The high moisture meat analog (HMMA) of claim 47, comprising:
a vegetarian protein composition, and
an oleogel composition comprising:
about 5% by weight of the oleogel of ethylcellulose,
about 38% by weight of the oleogel of the one or more monoacylglycerols selected from glyceryl monooleate, glyceryl monopalmitate and glyceryl monostearate,
and about 57% by weight of the oleogel of the plant-derived lipid,
wherein the high moisture meat analog has a non-homogenous dispersion of lipids providing a marbled texture and/or appearance.

49. The high moisture meat analog (HMMA) of claim 47, comprising:
a vegetarian protein composition, and
an oleogel composition comprising:
about 5% by weight of the oleogel of ethylcellulose 45 cP,
about 19% by weight of the oleogel of glyceryl monooleate,
about 19% by weight of the oleogel of glyceryl monopalmitate or glyceryl monostearate,
and about 57% by weight of the oleogel of canola oil,
wherein the high moisture meat analog has a non-homogenous dispersion of lipids providing a marbled texture and/or appearance.

50. A method of preparing a high moisture meat analog (HMMA), comprising:
introducing a vegetarian protein composition into a feed assembly attached to an extruder,
introducing an oleogel composition into a feed assembly attached to the extruder, wherein the extruder comprises at least a primary feed assembly and optionally a second feed assembly,
thereby combining the vegetarian protein composition and the oleogel composition in the extruder to form an HMMA with a non-homogenous dispersion of fat providing a marbled texture and/or appearance.

51. The method of claim 50, wherein the extruder utilizes a cold extrusion process.

52. The method of claim 50, wherein the extruder is a co-rotating twin blade extruder.

53. The method of claim 50, wherein the primary feed assembly is positioned in zone 1 of the extruder.

54. The method of claim 50, wherein the second feed assembly is positioned in any one of zones 5-10 of the extruder.

55. The method of claim 50, wherein the second feed assembly is positioned on a cooling die system attached to the extruder.

56. The method of claim 50, wherein the cooling die system further comprises a static mixer.

57. The method of claim 50, wherein the second feed assembly comprises a forced feeder attachment.

58. The method of claim 50, wherein the second feed assembly comprises a vent port feeder attachment.

59. The method of claim 50, wherein the vegetarian protein composition and the oleogel composition are introduced through the same feed assembly.

60. The method of claim 50, wherein the vegetarian protein composition and the oleogel composition are introduced through different feed assemblies.

61. The method of claim 50, wherein the vegetarian protein composition and the oleogel composition are pre-mixed into a composite before introducing to the extruder.

62. The method of claim 61, wherein the composite is in the form selected from pellets, pastes, pieces, chunks, strands, mince, and combinations thereof.

63. The method of claim 61, wherein the composite is introduced into the extruder through the second feed assembly.

64. The method of claim 50, wherein the vegetarian protein composition is introduced through the primary feed assembly and the oleogel composition is added dropwise into the primary feed assembly during feeding.

65. The method of claim 50, wherein the vegetarian protein composition is introduced through the primary feed assembly and the oleogel composition is introduced through the second feed assembly.

66. The method of claim 59, wherein the oleogel composition is introduced continuously into the extruder.

67. The method of claim 59, wherein the oleogel composition is introduced intermittently into the extruder.

68. The method of claim 50, wherein the oleogel composition comprises about 1-20% ethylcellulose, about 25-50% monoacylglycerol, and about 40-75% plant-derived lipid.

69. The method of claim 68, wherein the plant-derived lipid is selected from a group consisting of soybean oil, rapeseed oil, canola oil, sunflower oil, safflower oil, peanut oil, cottonseed oil, coconut oil, fractionated coconut oil, palm oil, fractionated palm kernel oil, and combinations thereof.

70. The method of any one of claim 68, wherein the oleogel composition further comprises one or more starches or one or more dietary fibers, or combinations thereof.

71. The method of any one of claim 68, wherein the oleogel composition further comprises one or more of coloring agents, additional fats, binding agents, stabilizing agents, emulsifying agents, and combinations thereof.

72. The method of any one of claim 68, wherein the oleogel composition introduced into the extruder is incorporated into beads, pellets, chunks, paste, strands, and combinations thereof.

73. The method of any one of claim 68, wherein the oleogel composition introduced into the extruder is frozen.

74. The method of claim 50, wherein the vegetarian protein composition comprises proteins derived from non-genetically modified or commoditized or hybridized or genetically modified plants selected from a group consisting of soybean (soy), corn, peas, peanuts, almonds, nuts, chickpeas, favas, wheat gluten, and combinations thereof.

75. The method of claim 50, wherein the HMMA further comprises one or more of emulsifiers, surfactants, sugars, starches, oligosaccharides, coloring agents, binding agents, stabilizing agents, flavor enhancers, flavoring agents, fragrance enhancers, vitamins, minerals, antioxidants, essential oils, pH regulators, dietary fibers, gluten, and combinations thereof.

76. The method of claim 50, wherein the vegetarian protein composition further comprises water and when introduced into the extruder comprises previously extruded pre-HMMA.

77. The method of claim 50, wherein the rotation speed of the twin-screw varies from between about 200 to about 800 rpm.

78. The method of claim 50, wherein the specific mechanical energy going into the extrusion is about 50 to about 80 Wh/kg.

79. The method of claim 50, wherein the temperature in one or more zones of the extruder ranges from about −20° C. to about −10° C., about −10° C. to about 0° C., about 0° C. to about 10° C., about 10° C. to about 20° C., about 20° C. to about 30° C., about 30° C. to about 40° C., about 40° C. to about 50° C., about 50° C. to about 60° C., about 60° C. to about 70° C., about 70° C. to about 80° C., about 80° C. to about 90° C., and about 90° C. to about 100° C.

80. The method of claim 50, further comprising a second extruder.

81. The method of claim 80, wherein the second extruder is a single-screw extruder.

82. The method of claim 80, wherein the second extruder is a forming extruder.

83. The method of any one of claim 50, wherein the HMMA is in the form selected from sheets, mince, pellets, paste, agglomerations, chunks, or patties.

84. A method of preparing a high moisture meat analog (HMMA), comprising:
introducing a vegetarian protein composition into a primary feed assembly of a twin-screw extruder,
introducing an oleogel composition comprising about 1-10% by weight of the oleogel of ethylcellulose, about 20-50% by weight of the oleogel of one or more monoacylglycerols, and about 40-75% by weight of the oleogel of a plant-derived lipid,
thereby combining the vegetarian protein composition and the oleogel composition in the extruder to form the HMMA with a non-homogenous dispersion of fat providing a marbled texture and/or appearance.
